(19) United States
(12) Patent Application Publication
(10) Pub. No.: US 2009/0055526 A1
(43) Pub. Date: Feb. 26, 2009

(54) Information terminal, server apparatus, and information processing method

(75) Inventors: Sawako Mikami, Tokyo (JP); Hirokazu Takatama, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/222,922

(22) Filed: Aug. 20, 2008

(30) Foreign Application Priority Data
Aug. 22, 2007 (JP) 215812/2007
Mar. 14, 2008 (JP) 66205/2008

(51) Int. Cl. G06F 15/173

(52) U.S. Cl. 709/224

(57) ABSTRACT

An information terminal that reduces the effort of presence input is provided. The information terminal is connected via a network to a server for disclosing a presence that is a present state of each user or each object, and includes: a display unit for displaying a presence input screen that is a screen for inputting the presence; a storage unit storing a terminal identifier that differs from one user terminal to another and information on the presence input screen; and a control unit that causes the presence input screen to be displayed on the display unit upon receiving a presence input request signal that is a signal for requesting input of the presence from another information terminal via the network, and when the presence is inputted via an operating unit, transmits the terminal identifier together with the presence to the server.

### BACKGROUND OF THE INVENTION

1. Field of the Invention

The present invention relates to an information terminal, a server apparatus and an information processing method for verifying a state indicating a current location or situation of a person or an object.

2. Description of the Related Art

State management systems and state disclosure systems are known as systems for verifying a state of a person or an object. In such systems, a current state in regards to a person or an object is referred to as a “presence”.

When targeting a person, a presence corresponds to information indicating situations such as “at work” or “on a break” or to information indicating the whereabouts of the person. When targeting an object, examples of a presence include information indicating inventory status. Furthermore, in the case where a target is kept at a controlled temperature, examples of a presence include information indicating the temperature management condition of a storage locker.

Methods of inputting a presence to a system include: a method in which a user to become a user of the system operates an information terminal to input a presence; a method in which a presence is inputted by the detection of an RFID (Radio Frequency Identification) respectively assigned to persons and objects by a sensor, and the like. By recording the presence of a person or an object and ensuring that such presence is verifiable at all times, various information and services corresponding to the presence can be provided.

However, a problem occurs in which the reliability of a presence recorded on a system decreases when a user forgets to input a presence in the method where an information terminal is operated by a user to input a presence, or when the reading accuracy of a sensor is low in the method where an RFID is to be detected by the sensor.

Systems for preventing a user from forgetting to input a presence and reminding the user to input a presence include a state management system (Japanese Patent Laid-Open No. 2001-147891) and a user state disclosure system (Japanese Patent Laid-Open No. 2004-265345).

The state management system disclosed in Japanese Patent Laid-Open No. 2001-147891 is a system for referencing a presence of a request destination user which is stored in a database when a request source user wishes to learn the presence of the request destination user. In this case, when the presence of the request source user is information that is older than the presence of the request destination user, either the request is denied or the request source user is prompted to input a presence. The state management system requires that a user who desires to reference the presence of another user update his/her own presence at a similar frequency, and is able to solve the problem of decreasing presence reliability by having the user input a presence in response to the request.

The user state disclosure system disclosed in Japanese Patent Laid-Open No. 2004-265345 is a system in which a terminal prompts its user thereof to update presence by requesting the user thereof to input a presence at regular time intervals. With this system, since the user inputs a valid presence at regular time intervals, the problem of decreasing presence reliability can be solved.

The techniques described above have the following problems.

The state management system disclosed in Japanese Patent Laid-Open No. 2001-147891 has a problem in that if the request destination user has not inputted a presence, the request source user is unable to learn the presence of the request destination user. This is because a request for inputting a presence input request is not issued to the request destination user even when the request source user desires to reference the presence of the request destination user, and the system is premised on the presence of the request destination user being stored in the database.

The user state disclosure system disclosed in Japanese Patent Laid-Open No. 2004-265345 has a problem in that inputting of a presence performed by the user will come to nothing if the inputted presence is not referenced. In addition, useless input work cannot be skipped even when the same presence continues over a certain period of time. For instance, assuming that an input request is made to the user every hour, even when it is known that a meeting will last for three hours, the user must input a presence three times during the three hour-meeting. From the user's perspective, as long as a presence input request is issued, the same presence must be inputted at regular time intervals regardless of whether his/her presence is to be referenced by others. Furthermore, as a consequence, from the perspective of the apparatus on the input receiving-side, a presence that does not have to be updated is to be received over and over again.

The present invention has been made to solve problems found in techniques such as described above, and a purpose thereof is to provide an information terminal, a server apparatus and an information processing method that reduces the effort of presence input.

### SUMMARY OF THE INVENTION

An information terminal according to the present invention for achieving the purpose described above is an information terminal connected via a network to a server for disclosing a presence that is a present state of each user or each object, and includes.

a display unit for displaying a presence input screen that is a screen for inputting the presence;

a storage unit storing a terminal identifier that differs from one user terminal to another and information on the presence input screen; and

a control unit that causes the presence input screen to be displayed on the display unit upon receiving a presence input request signal that is a signal for requesting input of the presence from another information terminal via the network, and when the presence is inputted via an operating unit, transmits the terminal identifier together with the presence to the server.

In addition, a server apparatus according to the present invention for achieving the purpose described above is a server apparatus connected via a network to first and second information terminals, and includes:

a storage unit storing information on one or more candidates to become a forwarding destination of a presence input request signal that is a signal for requesting a presence, or a present state of a user, as well as on forwarding condition with respect to the second information terminal; and

a control unit for selecting a candidate satisfying the forwarding conditions from the one or more candidates upon receiving the presence input request signal from the first information terminal to the second information terminal, and forwarding the presence input request signal to one or more selected candidates.

Furthermore, an information processing method according to the present invention for achieving the purpose described above is an information processing method performed by an information terminal connected via a network to a server for disclosing a presence that is a present state of each user or each object, wherein the information processing method:

stores a terminal identifier that differs from one user terminal to another and information on a presence input screen;

causes the presence input screen to be displayed on a display unit upon receiving a presence input request signal that is a signal for requesting input of the presence from another information terminal via the network; and

transmits the terminal identifier-together with the presence to the server when the presence is inputted via an operating unit.

According to the present invention, since a presence need only be inputted when a request for the presence is made from the outside, work load is reduced compared to a case where presence input is required at regular time intervals. Since the inputted presence is disclosed to other users by the server whereby the other users become capable of referencing the presence, requests from the other users for the presence can be prevented.

### BRIEF DESCRIPTION OF THE DRAWINGS

FIG. 1 is a block diagram showing a configuration example of an information terminal according to an embodiment of the present invention;

FIG. 2 is a block diagram showing a configuration example of an information processing system according to a first embodiment;

FIG. 3 is a block diagram showing a configuration example of an information terminal shown in FIG. 2;

FIG. 4 is a block diagram showing a configuration example of a presence server shown in FIG. 2;

FIG. 5 is a flowchart showing an operation procedure of the information processing system shown in FIG. 2;

FIGS. 6A and 6B are diagrams showing display examples of the presence of the user B on an information terminal;

FIGS. 7A to 7D are diagrams showing examples of presence input screens;

FIGS. 8A to 8D are diagrams showing examples of input screens of a presence ending time;

FIGS. 9A and 9B are diagrams for describing an input method of a presence ending time or a presence remaining time;

FIG. 10 is a block diagram showing a configuration example of an information processing system according to a third embodiment;

FIG. 11 is a flowchart showing an operation procedure of the information processing system shown in FIG. 10;

FIG. 12 is a block diagram showing a configuration example of an information processing system according to a fourth embodiment;

FIG. 13 is a block diagram showing a configuration example of a forwarding setting server shown in FIG. 12;

FIG. 14 is a flowchart showing an example of an operation procedure of a transmission destination terminal decision unit;

FIG. 15 is a block diagram showing another configuration example of the information processing system according to the fourth embodiment;

FIG. 16 is a block diagram showing a configuration example of an information processing system according to a fifth embodiment;

FIG. 17 is a flowchart showing operations of the information processing system according to the fifth embodiment;

FIG. 18 is a diagram showing a display example of a presence;

FIG. 19 is a block diagram showing a configuration example of an information processing system according to a sixth embodiment;

FIG. 20 is a block diagram showing a configuration example of an information terminal 5 shown in FIG. 19;

FIG. 21 is a block diagram showing a case where the information processing system according to the sixth embodiment is applied to the third embodiment;

FIG. 22 is a block diagram showing a case where the information processing system according to the sixth embodiment is applied to the fifth embodiment;

FIG. 23 is a flowchart showing an operation procedure of the information processing system according to the sixth embodiment;

FIG. 24 is a block diagram showing a configuration example of an information processing system according to a seventh embodiment;

FIG. 25 is a block diagram showing a configuration example of an answering machine/forwarding setting server shown in FIG. 24;

FIG. 26 is a block diagram showing a case where the information processing system according to the seventh embodiment is applied to the third embodiment;

FIG. 27 is a block diagram showing a case where the information processing system according to the seventh embodiment is applied to the fifth embodiment;

FIG. 28 is a flowchart showing an operation procedure of an information processing system according to an eighth embodiment;

FIG. 29 is a flowchart showing an operation procedure of an information processing system according to a ninth embodiment;

FIG. 30 is a block diagram showing a configuration example of an information terminal according to a tenth embodiment;

FIG. 31 is a flowchart showing an operation procedure of an information processing system according to the tenth embodiment;

FIG. 32 is a block diagram showing a configuration example of an information processing system according to an eleventh embodiment;

FIG. 33 is a block diagram showing a configuration example of an information terminal according to the eleventh embodiment;

FIG. 34 is a block diagram showing a configuration example of a service providing server according to the eleventh embodiment;

FIG. 35 is a block diagram showing a configuration example of a judgment server according to the eleventh embodiment;

FIG. 36 is a flowchart showing an operation procedure of the information processing system according to the eleventh embodiment;

FIG. 37 is a flowchart showing an operation procedure of an information processing system according to a twelfth embodiment; and

FIG. 38 is a flowchart showing an operation procedure of an information processing system according to a thirteenth embodiment.

### DETAILED DESCRIPTION OF THE PREFERRED EMBODIMENTS

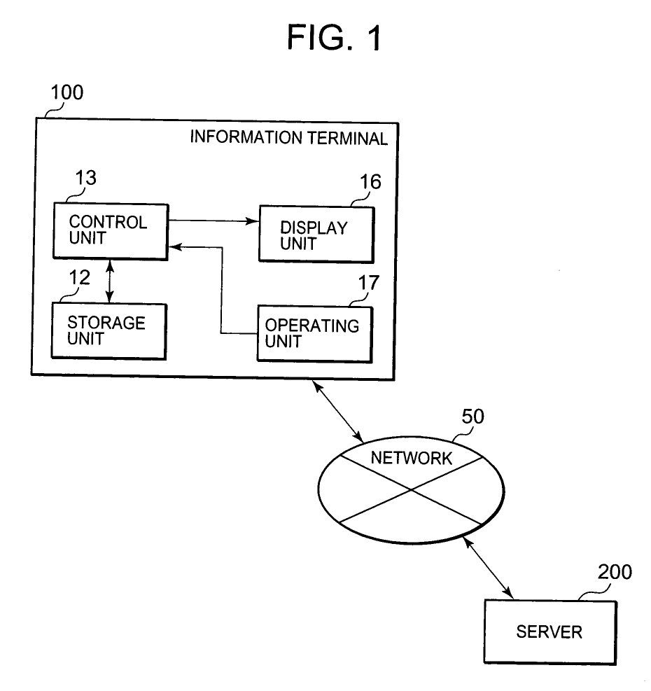

An information terminal according to an embodiment of the present invention will now be described. FIG. 1 is a block diagram showing a configuration example of an information terminal according to the present embodiment.

As shown in FIG. 1, an information terminal 100 according to the present embodiment is connected via a network 50 to a server 200 for disclosing a presence that is a present state of each user.

The information terminal 100 includes: a display unit 16 for displaying a presence input screen that is a screen for inputting a presence; a storage unit 12 storing a terminal identifier that differs from one user terminal to another and information on the presence input screen; and a control unit 13.

The control unit 13 causes the presence input screen to be displayed on the display unit 16 upon receiving a presence input request signal that is a signal for requesting input of a presence. When a presence is inputted via an operating unit 17, the control unit 13 transmits a terminal identifier together with the presence to the server 200.

With the information terminal according to the present embodiment, since the presence input screen is displayed when the information terminal receives a presence input request from another information terminal, a presence need only be inputted when a request is made from another user. Compared to a case where a presence is to be inputted at regular time intervals, the effort of input on the part of the user is reduced. In addition, an updated presence is disclosed by having the server a receive presence accompanied by a terminal identifier and update the presence of a user identified by the terminal identifier. An example of an information processing system including the information terminal according to the present embodiment will now be described.

### First Embodiment

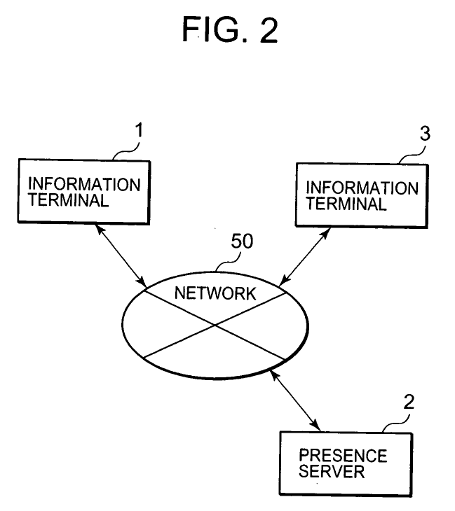

A configuration of an information processing system according to the present embodiment will be described below. FIG. 2 is a block diagram showing a configuration example of an information processing system according to the present embodiment.

As shown in FIG. 2, the information processing system includes an information terminal carried by a user and a presence server 2. In the present embodiment, it is assumed that a user A carries an information terminal 1 and a user B carries an information terminal 3. Each apparatus is connected via a network 50 such as the Internet or an intranet. Although the present embodiment assumes a case including two information terminals in correspondence with the number of users in order to prevent the description from becoming too complicated, the number of users is not limited to two and the number of information terminals is also not limited to two. A detailed description on a configuration of each apparatus will be given below.

The information terminals 1 and 3 are information devices such as a mobile telephone, a personal computer (hereinafter referred to as a PC), a PDA (Personal Digital Assistant), a car navigation system, and the like. The mobile telephone as used herein is provided with, in addition to a verbal communication function, a function for transmitting and receiving text information such as an electronic mail as well as a function for transmitting signals to a server connected via the network 50 and downloading webpages from the server.

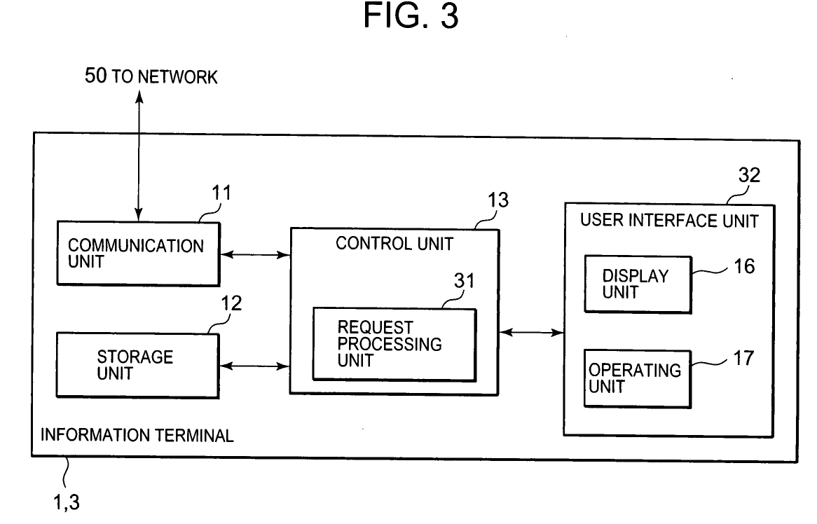

A configuration of the information terminals 1 and 3 will now be described. FIG. 3 is a block diagram showing a configuration example of the information terminal shown in FIG. 2.

As shown in FIG. 3, the information terminals 1 and 3 respectively include: a communication unit 11 that transmits and receives information to/from other information terminals and the presence server 2; a storage unit 12 for storing information transmitted and received at the communication unit 11; a control unit 13 that controls the respective units; and an user interface unit 32. The user interface unit 32 includes a display unit 16 for displaying information and an operating unit 17 to be used by a user for inputting instructions.

The control unit 13 includes a request processing unit 31 that performs presence input/output requests. The control unit 13 includes a CPU (central processing unit; not shown) that executes processing according to a program, and a memory (not shown) for storing the program. The execution of a program by the CPU causes the request processing unit 31 to be virtually-constructed inside the information terminal.

The storage unit 12 stores a message requesting presence input and information on a presence input screen that is a screen for inputting presence. Each apparatus is assigned a terminal identifier that is an identifier that differs from one apparatus to the next. In addition to the terminal identifier of its own apparatus, the storage unit 12 also stores terminal identifiers of other apparatuses between which a communication connection is established.

When transmitting/receiving signals or information between the apparatuses, the transmitted/received signals and information are respectively attached with the terminal identifier of its own apparatus as the transmission source and the terminal identifier of the partner apparatus as the transmission destination.

Each user is able to operate an information terminal to register his/her own schedule in the presence server 2. Registration of schedules is not limited to using an information terminal, and other information processing apparatuses capable of establishing a communication connection with the presence server 2 may be used instead. When registering a schedule using an apparatus other than an information terminal, information on a user ID that is a user's own identifier is transmitted together with the schedule to the presence server 2.

In order to verify a presence of the user B, the user A operates the information terminal 1 and causes the information terminal 1 to connect to the presence server 2. When the user A inputs his/her intent to request the presence of the user B by operating the information terminal 1, the information terminal 1 transmits a presence request signal including the terminal identifier of the information terminal 3 of the user B and information to the effect that the presence of the user B is requested to the presence server 2.

When receiving the presence of the user B from the presence server 2, the control unit 13 of the information terminal 1 causes the received presence to be displayed on the display unit 16. If the presence of the user B cannot be received from the presence server 2, the control unit 13 causes a notification to that effect to be displayed on the display unit 16. As the user A operates the information terminal 1 to input his/her intent to request a presence to the information terminal 3, the information terminal 1 transmits a presence input request signal that is a signal requesting input of a presence to the information terminal 3 via the communication unit 11 and the network 50.

When the information terminal 3 receives the presence input request signal from the information terminal 1, the request processing unit 31 reads out a message requesting input of a presence as well as the presence input screen from the storage unit 12 and causes the message and the screen to be displayed on the display unit 16. As the user B operates the operating unit 17 to input a presence, the request processing unit 31 transmits the inputted presence to the presence server 2.

The user interface unit 32 may be arranged so as to include a touch panel combining the display unit 16 and the operating unit 17. In addition, a speaker (not shown) for audio output may be provided at the user interface unit 32, whereby the request processing unit 31 converts the message requesting input of a presence to an audio signal and causes the signal to be outputted from the speaker. Furthermore, since the request for presence input is conveyed to the user by displaying the presence input screen on the display unit 16, the displaying of a message requesting presence input may be omitted. The case described hereinafter assumes that the displaying of the message is omitted.

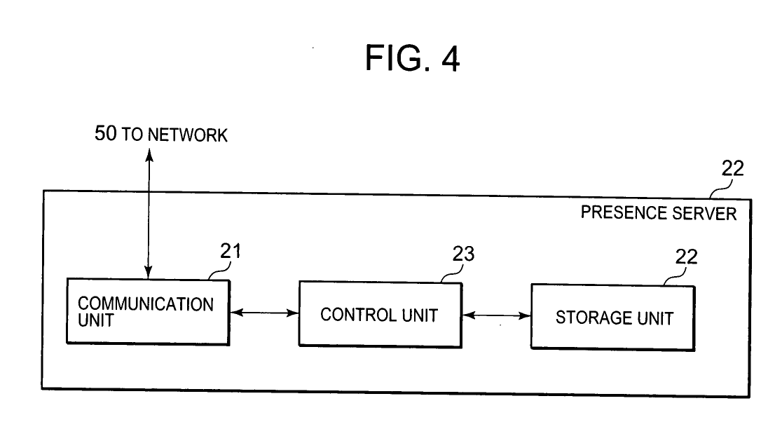

A configuration of the presence server 2 will now be described. FIG. 4 is a block diagram showing a configuration example of the presence server shown in FIG. 2.

The presence server 2 is a server for managing schedules of respective users. As shown in FIG. 4, the presence server 2 includes: a communication unit 21 that transmits and receives information to/from other information terminals; a storage unit 22 for storing information transmitted and received at the communication unit 21; and a control unit 23 for controlling the respective units.

The storage unit 22 stores schedule information for each user. Schedules are classified according to user and further sorted by date. All fields of a schedule to be stored need not be filled in. In addition, the storage unit 22 stores an identifier conversion table that pairs a terminal identifier of each information terminal with a user ID of the user carrying the information terminal.

The control unit 23 includes a CPU (not shown) that executes processing according to a program, and a memory (not shown) for storing the program. Upon receiving schedules from the respective information terminals 1 and 3, the control unit 23 attaches the terminal identifiers of the transmission source information terminals to the received schedules and registers the same in the storage unit 22. When receiving a user ID together with the schedule, the control unit 23 references the identifier conversion table and identifies the terminal identifier of the information terminal corresponding to the user ID, and registers the schedule together with the terminal identifier. This is performed so that which user the schedule is from can be identified based on the terminal identifier. In addition, upon receiving the presence from the information terminal, the control unit 23 identifies the terminal identifier of the information terminal that is the transmission source of the presence, identifies the schedule to which the same terminal identifier had been attached in the storage unit 22, and updates the schedule by adding the presence thereto.

Upon receiving a presence request signal requesting the presence of the user B from the information terminal 1 via the communication unit 21, the control unit 23 identifies the schedule of the user B from the terminal identifier of the information terminal 3 included in-the presence request signal. If an appointment has been entered in the schedule as the presence of a time of day at which the presence request signal was received, the presence is sent back as a response to the information terminal 1. On the other hand, when the presence of the user B is not registered, information to the effect that the presence has not been registered is sent back to the information terminal 1.

While the above configuration has been described using a case where the user A verifies the presence of the user B, verification of the presence of the user A by the user B is performed in the same manner.

Operations of the information processing system according to the present embodiment will be described below.

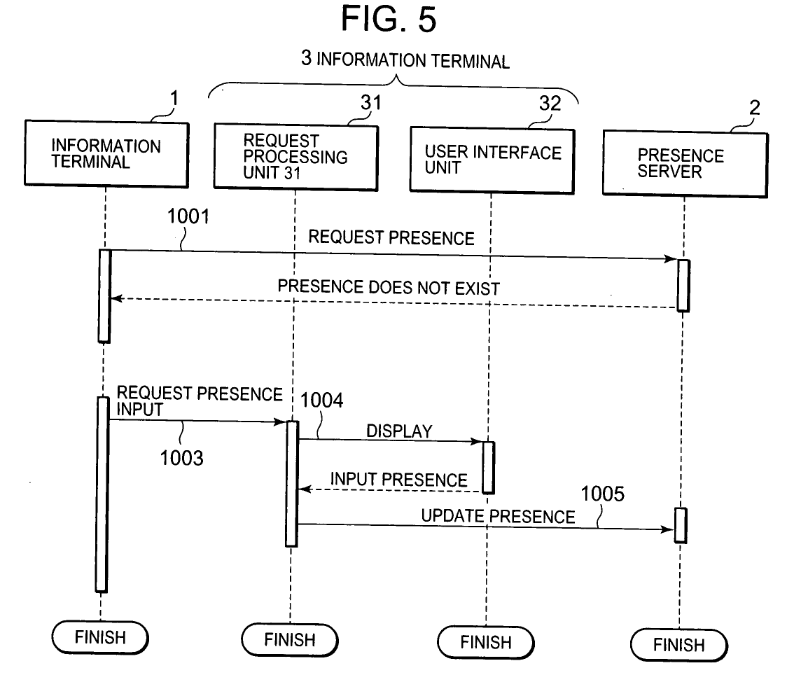

FIG. 5 is a flowchart showing an operation procedure of the information processing system shown in FIG. 2. In this case, it is assumed that the user A wishes to learn about the presence of the user B.

As the user A operates the information terminal 1 to input a request for the presence of the user B, the information terminal 1 transmits a presence request signal requesting the presence of the user B to the presence server 2 via the network 50 (step 1001). Upon receiving the presence request signal from the information terminal 1, the presence server 2 references the identifier conversion table and reads out the terminal identifier of the information terminal 3 included in the presence request signal. A registered schedule attached with the same terminal identifier is read out from the storage unit 22 and transmitted to the information terminal 1. The information terminal 1 displays the schedule received from the presence server 2.

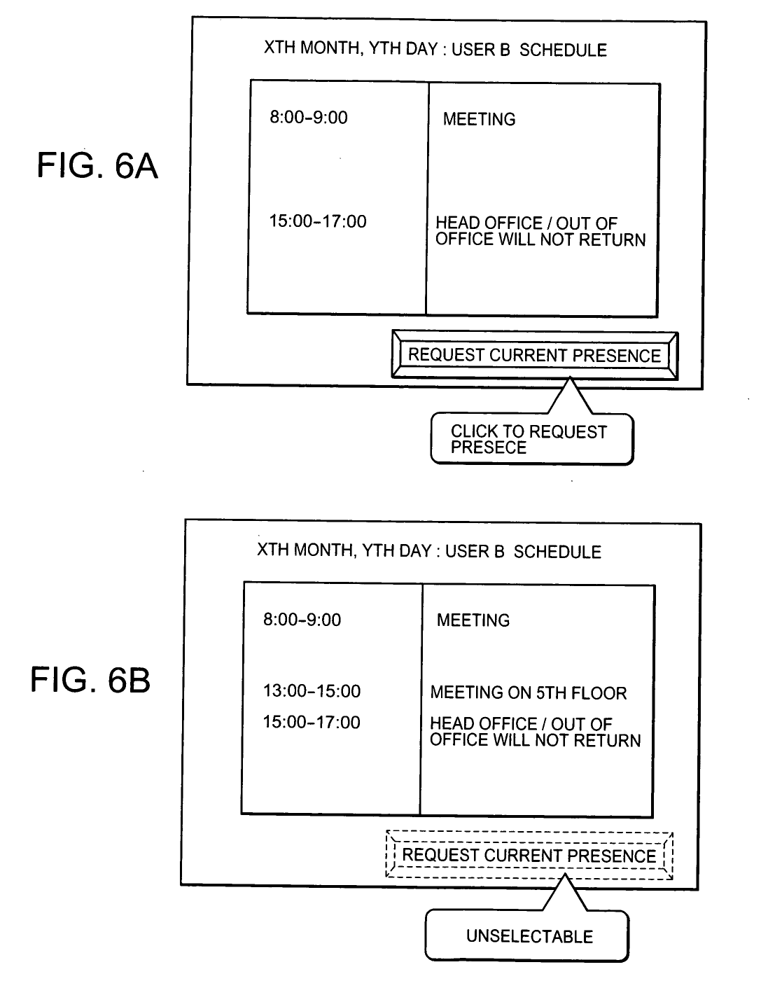

FIG. 6 is a diagram showing display examples of a presence of the user B on an information terminal. FIG. 6(A) shows a screen of a case where a presence is not registered for a time period between 13:00 and 15:00 while FIG. 6(B) shows a screen of a case where a presence has been registered for the same time period.

The screen shown in FIG. 6(A) indicates that, on the Xth day of the Yth month, the user B: has a meeting scheduled from 8:00 to 9:00; will be out of the office from 15:00 to 17:00; and thereafter will not return. No appointments are registered between 9:00 and 15:00. When another user requests the presence of the user B between 9:00 to 15:00, not only is a “request current presence” button such as that shown in the bottom right of the screen displayed, but the button can also be activated.

When the information terminal is a PC, the user can activate the “request current presence” button by operating the mouse to align the mouse cursor with the button and then clicking the mouse. When the information terminal is a mobile telephone, the user need only press a cursor movement button on the operating unit 17 to move the cursor to the position of the “request current presence” button and press an enter button of the operating unit 17.

The screen shown in FIG. 6(B) indicates that, in addition to the appointments shown in FIG. 6(A), a meeting has been scheduled on the 5th floor from 13:00 to 15:00. The screen shown in FIG. 6(B) is a screen downloaded from the presence server 2 to the information terminal 1 when the user A requested the presence of the user B between 13:00 and 15:00. Since the presence of the user B between 13:00 and 15:00 is apparent from the screen, the display of FIG. 6(B) is arranged so that the “request current presence” button cannot be activated.

In this case, it is assumed that the information terminal 1 receives the screen shown in FIG. 6(A) from the presence server 2 and displays the same on the display unit 16 (step 1002). Since appointments of the user B from 13:00 to 15:00 are not displayed, when the “request current presence” button is activated by an operation performed by the user A, the information terminal 1 sends a presence input request signal to the information terminal 3 via the network 50 (step 1003).

When the information terminal 3 receives the presence input request signal from the information terminal 1 via the communication unit 11, the request processing unit 31 reads out the presence input screen from the storage unit 12 and causes the screen to be displayed on the display unit 16 (step 1004). At this point, if the information terminal 3 is a mobile telephone, the vibrator of the mobile telephone may be activated to notify the user B that a request for presence input has been made. In addition, in order to inform the user B as to who had requested presence input performed by the user B, the request processing unit 31 may be arranged to display a request source user name (user A) on the display unit 16. This can be enabled by storing, in advance, a table in which terminal identifiers and user names are recorded in pairs such as a phonebook of a mobile telephone in the storage unit 12, and having the request processing unit 31 identify the user A from the terminal identifier of the information terminal 1 that is the transmission source of the presence input request signal.

There are several conceivable methods of inputting presence. One method is to display a field for presence input on the screen, and have the user operate character input keys on the operating unit 17 to directly input a presence into the field. Another method is to display a plurality of presences conceivable as input candidates on the screen, and have the user operate the operating unit 17 and select from the plurality of presences.

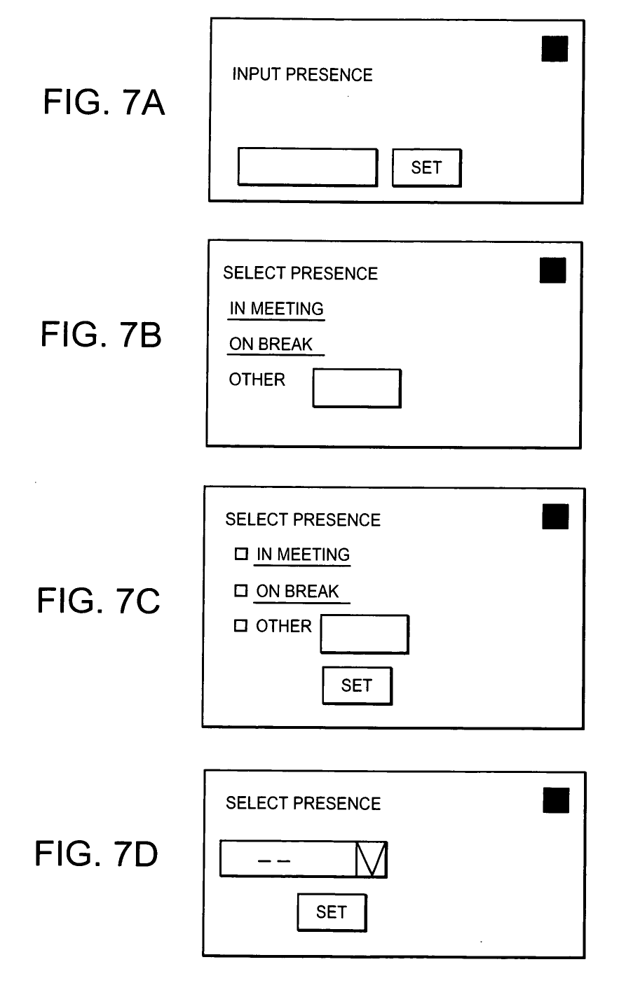

FIGS. 7(A) to 7(D) are diagrams showing examples of presence input screens. A brief description on the respective display screens and a presence input method will be given below.

In FIG. 7(A), an input field for directly inputting a presence and a “set” button for setting the inputted presence are displayed. A presence is written into the input field and the “set” button is activated.

In FIG. 7(B), “in meeting”, “on break”, and “other” are selectably displayed as presence options. When selecting “in meeting” or “on break”, activating a banner of the presence to be selected shall suffice. When selecting “other”, a presence is inputted into the input field.

In FIG. 7(C), check boxes are respectively displayed beside the three options. When selecting “in meeting” or “on break”, a check box corresponding to the presence to be selected is checked and the “set” button is activated. When selecting “other”, the check box for selecting “other” is checked, a presence is inputted into the presence input field and-the “set” button is activated.

In FIG. 7(D), by activating the portion denoted by “V”, a plurality of presence options (not shown) is displayed on the screen. As described above, options include “in meeting”, “on break”, “other”, and the like. A presence to be targeted is selected from the displayed plurality of options and the “set” button is activated.

When a presence is inputted via the user interface unit 32, the request processing unit 31 of the information terminal 3 transmits presence update information including information on the presence to the presence server 2 via the communication unit 11 (step 1005). Upon receiving the presence update information from the information terminal 3, the presence server 2 writes the presence into the schedule of the user B who is identified from the terminal identifier of the information terminal 3. In this manner, the presence of the user B disclosed by the presence server 2 is updated.

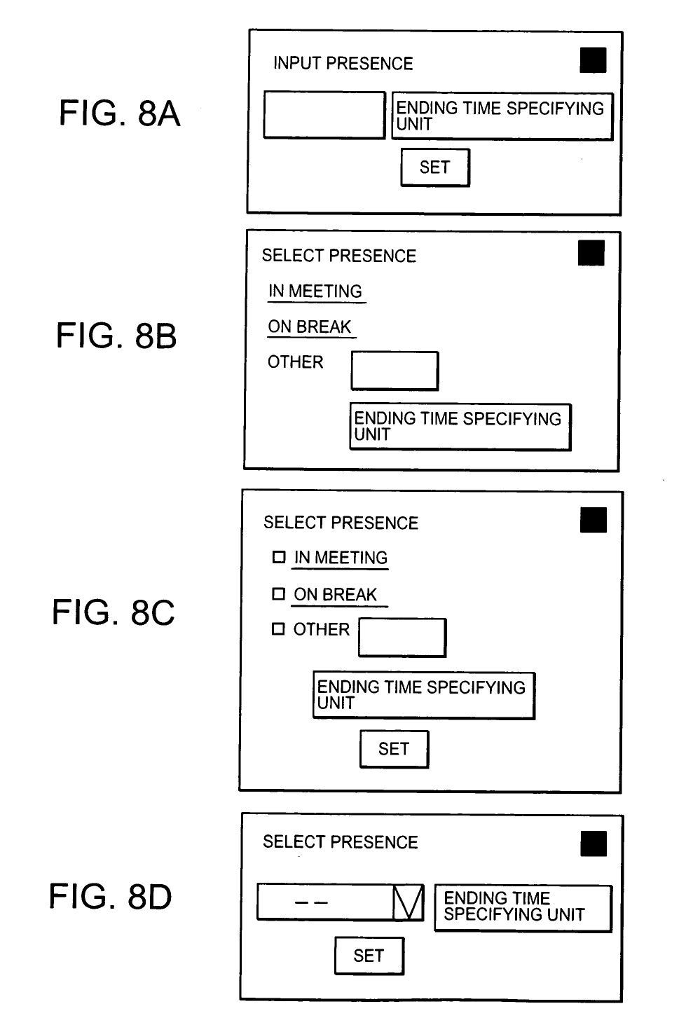

When inputting a presence as described above, a duration of the presence may be set. FIG. 8 is a diagram showing examples of input screens of a presence ending time.

FIG. 8(A) shows a case where a button of an ending time specifying unit has been provided on the presence input screen shown in FIG. 7(A). FIG. 8(B) shows a case where a button of an ending time specifying unit has been provided on the presence input screen shown in FIG. 7(B). In the same manner as FIGS. 8(A) and 8(B), FIGS. 8(C) and 8(D) show cases where a button of an ending time specifying unit has been respectively provided on the presence input screens shown in FIGS. 7(C) and 7(D). By activating this button, a field for setting a presence ending time or a presence remaining time appears on the input screen.

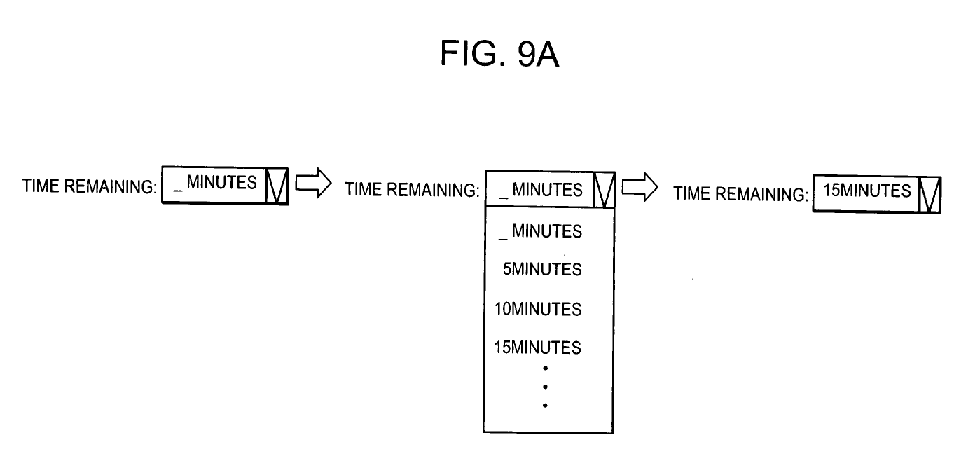

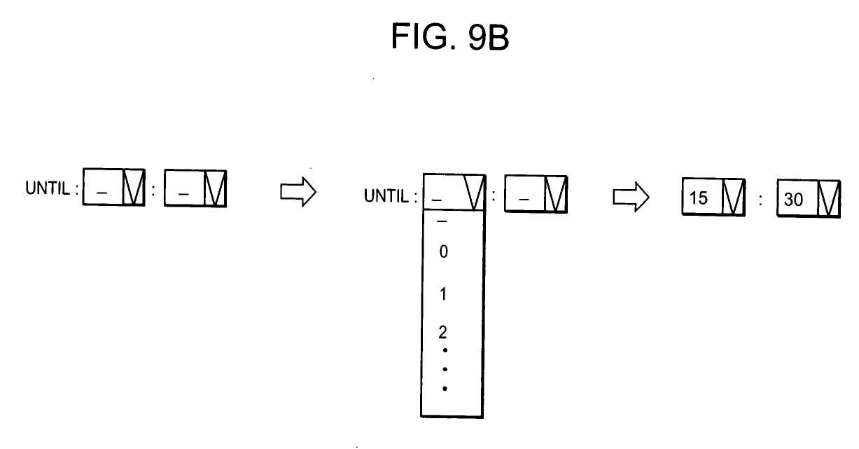

FIG. 9 is a diagram for describing an input method of a presence ending time or a presence remaining time. FIG. 9(A) shows a display example for setting a presence remaining time, while FIG. 9(B) shows a display example for setting a presence ending time.

A case of setting a presence remaining time will now be described. When the ending time specifying unit button shown in FIG. 8 is activated, a display shown at the left end in FIG. 9(A) appears on the input screen. When a portion denoted by “V” on the display is activated, a display shown at the center of FIG. 9(A) appears. The display at the center of FIG. 9(A) provides a list of durations in five-minute increments. Subsequently, when a duration corresponding to-the remaining time of the presence is selected from the listed durations, the selected duration is set as shown at the right end of FIG. 9(A). For now, a case is shown where the remaining time has been set to 15 minutes.

A case of setting a presence ending time will now be described. When the ending time specifying unit button shown in FIG. 8 is activated, an hour unit field and a minute unit field appear on the input screen as shown at the left end of FIG. 9(B). When a portion of the time unit field denoted by “V” is activated, a display shown at the center of FIG. 9(B) appears. The display at the center of FIG. 9(B) provides a list of hours in one-hour increments. Next, an hour unit of the presence ending time is selected from the listed hours. When a minute unit is selected in the same manner as in the hour unit, the selected “hour” and “minute” are set as shown at the right end of FIG. 9(B). For now, a case is shown where the ending time has been set to 15:30.

As described above, once the user B sets a presence ending time or a presence remaining time by operating the operating unit 17, the request processing unit 31 inserts information on the presence ending time or the presence remaining time into the presence update information and transmits the same to the presence server 2. Upon receiving the presence update information including a presence and an ending time or a remaining time thereof from the information terminal 3, the presence server 2 updates the presence in the schedule of the user B and discloses the updated schedule.

With the system according to the present embodiment, by sending a presence input request signal to an information terminal of a person whose presence has not been inputted to a schedule disclosed on a server, a presence input screen is displayed on the information terminal. When the user inputs a presence on the input screen, the information is transmitted from the information terminal to the server and the schedule in the server is updated. Accordingly, the current whereabouts of a person can be known by accessing the server and verifying the person's presence after the schedule is updated. Since a presence update need only be performed when there is a presence request in response to the request, the effort of inputting a presence can be reduced in comparison to a case where a presence is inputted at regular time intervals.

The work load on the part of the user for inputting a presence can be further reduced by displaying several presence candidates and having the user select a presence from the candidates. However, only one candidate need be displayed. For example, when the presence is “in meeting”, instead of having to input the characters “in meeting”, if the displayed candidate is “in meeting”, the user need only input an instruction to decide on the presence.

While the screen shown in FIG. 6(A) reveals that certain time periods in the schedule are left blank, a predetermined presence may be disclosed for time periods for which a presence has not been registered. Examples of predetermined presences may include “in office” or “at desk”. This also applies to a case where, although a presence has been inputted by the user, a subsequent presence is not registered at the ending time of the presence.

In addition, there are cases where, while a presence has been inputted by the user in response to a presence input request, a validity period of the presence cannot be determined because neither a presence ending time nor a presence remaining time has been inputted. As a way of dealing with a case where neither an ending time nor a remaining time is inputted, a predetermined remaining time may be set. Information on the remaining time is to be stored in the storage units 12 of the information terminals 1 and 3. For example, assuming that the predetermined remaining time is one hour, when the user inputs “meeting” as a presence into an information terminal at the Yth hour, the request processing unit 31 of the information terminal transmits presence update information including information to the effect that the remaining time is one hour and information on the presence “meeting” to the presence server 2.

Alternatively, information on a predetermined remaining time may be stored in the storage unit 22 of the presence server 2 instead of in the storage units 12 of the information terminals 1 and 3. In this case, when the control unit 23 of the presence server 2 receives presence update information including neither a presence ending time nor a presence remaining time, a remaining time is read out from the storage unit 22 and the schedule is updated in accordance with the presence and the remaining time.

Furthermore, the presence disclosure method according to the presence server 2 is not limited to a case where the schedule of the user of a given day is displayed in its entirety as shown in FIG. 6. The presence server 2 may be arranged to disclose a single presence so as to correspond to a time period from the starting time to the ending time of the presence. Upon receiving presence update information including information on the ending time of the presence from an information terminal, the presence server 2 discloses the presence up to the ending time.

To provide a description using the screen shown in FIG. 6(B) as an example, when the user A operates the information terminal 1 at 13:00 on the Xth day of the Yth month to cause a presence request signal with respect to the user B to be transmitted from the information terminal 1 to the presence server 2, the presence server 2 transmits information reading “meeting on 5th floor” instead of the schedule shown in FIG. 6(B) to the information terminal 3.

Moreover, while the screen shown in FIG. 6(B) is arranged so that a presence input request cannot be made, the “request current presence” button may be activated to enable the button. This is due to the fact that there may be cases where the contents of the schedule of the user B are changed. A specific example will be described below with reference to the screen shown in FIG. 6(B).

After viewing the screen shown in FIG. 6(B), the user A makes a call at 13:00 to the conference room on the 5th floor in an attempt to contact the user B. However, if the venue of the 13:00 meeting has been changed from the 5th floor to the 4th floor, the user A will not be able to contact the user B. In such a case, when the user A operates the operating unit 17 of the information terminal 1 to activate the “current presence request” button on the screen, a presence input request signal is transmitted from the information terminal 1 to the information terminal 3. As the user B operates the information terminal 3 to input that the location of the meeting is to be changed to the 4th floor conference room, presence update information including the change is transmitted to the presence server 2.

Furthermore, while the user B has inputted his/her own presence when the presence of the user B was requested by the user A, the cue for the user B to input a presence is not limited to this arrangement. Instead, input may be performed using other inquiry signals as a cue.

Upon receiving inquiry information from the outside which need not be a presence input request signal, the request processing units 31 of the information terminals 1 and 3 take the reception as a cue and notifies the user of both the contents of the inquiry information and the presence input request via the user interface unit 32. Presence input is also requested because, from the fact that the inquiry is purposely made via a terminal, it is deduced that the inquiry source user has no idea of the current whereabouts and status of the inquiry destination user. In this case, a predetermined signal is arranged to be included in the inquiry information, whereby the request processing unit 31 judges whether information is inquiry information based on the presence or absence of the signal. A specific example will be described below.

In the event that the user A wishes to borrow an object “X” (where X is a book, written material, or the like) belonging to the user B, the user A operates the information terminal 1 to transmit inquiry information inquiring about the object “X” to the information terminal 3 of the user B. Upon receiving the inquiry information from the information terminal 1, the information terminal 3 causes the message inquiring about the object “X” and the presence input screen to be displayed on the display unit 16.

The meaning of the phrase “presence does not exist” as used in the present embodiment depends on the type of presences managed by the presence server 2.

In the present embodiment, the presence server 2 cooperates with a scheduler so as to manage appointments registered in the scheduler as presences and, as such, “presence does not exist” is synonymous with “no appointments are registered in the scheduler”.

Meanwhile, the presence server 2 is also capable of managing presences inputted by users or via various sensors. In this case, “presence does not exist” is synonymous with “no valid presences exist”. A valid presence refers to a presence for which a long time has not elapsed from its last update. For example, a presence updated within the last five minutes shall be considered valid. The meaning of “presence does not exist” shall be the same for the subsequent examples.

According to the present invention, since a presence need only be inputted when a request for the presence is made from the outside, work load is reduced compared to a case where presence input is required at regular time intervals. Since the inputted presence is disclosed to other users by the server and other users will be able to reference the presence, requests for the presence from other users can be prevented.

### Second Embodiment

While the first embodiment is arranged so that a user A to be a presence input request source requests input of a presence to a user B to be a presence input request destination, the present embodiment is arranged so that an input request for the presence of the user B can be made from a presence input request source to presence input request destinations including other information terminals owned by the user B or users other than the user B. The present embodiment is arranged so that one of three methods described below is selectable when requesting presence input to another user or another terminal.

In a first method, when a user that is a presence input request destination owns a plurality of information terminals, a presence input request is made to one or more information terminals among the plurality of terminals. A second method involves having a user other than the user that is a presence input request destination input a presence on behalf of the same. A third method is a combination of the first and second methods.

A configuration of an information processing system according to the present embodiment will be described below. Hereinafter, while configurations and operations which differ from those of the first embodiment will be described in detail, descriptions on configurations and operations similar to those of the first embodiment will be omitted.

In the event that a user owns a plurality of information terminals, respective terminal identifiers thereof are registered in the identifier conversion table stored in the storage unit 22 of the presence server 2 shown in FIG. 4. When one user is determined, by referencing the identifier conversion table and looking up a terminal identifier registered together with a user ID of the user, the number of information terminals owned by the user as well as terminal identifiers thereof can be determined.

In addition, a list indicating, for each user, a user ID and an organization such as a section, a division, a company or the like to which the user belongs, is registered in the storage unit 22. Each organization is assigned an organization identifier that is an identifier that differs from one organization to the next. An organization identifier of an organization to which the user belongs which can be identified by a user name and a user ID is recorded in the list in correspondence to a user ID. By selecting a user and referencing the list, the organization to which the user belongs can be determined and, at the same time, other users belonging to the same organization can also be identified.

While the present embodiment is described using a case where a forwarding destination candidate of a presence input request signal is another user of the organization to which the user belongs, the forwarding destination candidate need not belong to the same organization and may instead be, for example, a conference room in the same area. In such a case, a presence indicating the whereabouts of a user that is the forwarding destination candidate is acquired and judged from the presence server or a terminal of the user.

When a presence input request instruction is inputted via the operating unit 17, the respective request processing units 31 of the information terminals 1 and 3 shown in FIG. 3 cause a screen for selecting any of the three methods described above is displayed on the display unit 16.

When the first method is selected via the operating unit 17, the request processing unit 31 connects to the presence server 2 to reference the identifier conversion table, and using the terminal identifier of the information terminal to be the destination of the presence input request signal, looks up information terminals used by the same user. Next, the request processing unit 31 causes names of information terminals corresponding to terminal identifiers registered together with the same user ID to be displayed on the display unit 16. When any of the displayed information terminals is selected via the operating unit 17, the request processing unit 31 transmits a presence input request signal addressed to the terminal identifier of the selected information terminal. The number of information terminals to be selected need not be limited to one, and a plurality of information terminals may be selected instead.

In addition, when the second method is selected via the operating unit 17, the request processing unit 31 connects to the presence server 2 to identify a user ID from the identifier conversion table using the terminal identifier of the information terminal to be the destination of the presence input request signal. Next, users belonging to the same organization as the user having the identified user ID are looked up in the aforementioned list. Consequently, when users belonging to the same organization are identified, the request processing unit 31 causes user names thereof to be displayed on the display unit 16. When any of the displayed user names is selected via the operating unit 17, the request processing unit 31 looks up a user ID from the selected user name, identifies a terminal identifier from the identifier conversion table using the user ID, and transmits a presence input request signal addressed to the terminal identifier. When doing so, the request processing unit 31 inserts the user ID of the user that is the presence input request target as well as information to the effect that the presence input request is for the user into the presence input request signal. The number of user names to be selected need not be limited to one, and a plurality of user names may be selected instead.

Furthermore, when the third method is selected via the operating unit 17, the request processing unit 31 respectively performs the first method and the second method described above, and causes a list of information terminals owned by the user that is the presence input request destination and a list of other users belonging to the organization to which the user belongs to be displayed on the display unit 16. When an information terminal and a user name are selected via the operating unit 17, the request processing unit 31 processes the selected information terminal in the same manner as in the case of the first method described above, and processes the selected user name in the same manner as in the case of the second method described above.

Operations of the information processing system according to the present embodiment will now be described with reference to FIG. 5. In this case, it is assumed that the user A is to request presence input to the user B. It is also assumed that the user B owns two information terminals of which one is a mobile telephone and the other is a PC. It is further assumed that the user B belongs to the same section as users C and D, and users C and D respectively carry mobile telephones as information terminals.

As described in step 1001 shown in FIG. 5, when the user A operates the information terminal 1 and inputs an instruction requesting presence input to the user B, the information terminal 1 displays a selection screen displaying the three methods on the display unit 16. When the user A operates the information terminal 1 and selects the first method, the information terminal 1 connects to the presence server 2 to identify information terminals owned by the user B from the identifier conversion table, and displays the two information terminals owned by the user B on the display unit 16. When the user A operates the information terminal 1 to set both of the two displayed information terminals, the information terminal 1 transmits presence input request signals to the two information terminals of the user B (step 1003).

As described above, when presence input request signals are transmitted to the two information terminals of the user B, both terminals display input screens for inputting a presence. Therefore, in the event that the user B is operating a PC to prepare a document while leaving his/her mobile telephone in a briefcase, although the user B will not notice the input screen on the mobile telephone, the user B will notice the input screen on the PC. In this manner, the presence input request can be notified to the user B.

Meanwhile, in the case where the user A selects the third method among the three methods described above when requesting presence input to the user B, the information terminal 1 connects to the presence server 2 to reference the identifier conversion table and the list, and displays the two information terminals of the user B as well as the names of the users C and D on the display unit 16. When the user A sets the two information terminals of the user B as well as the users C and D as presence input request destinations, the information terminal 1 transmits presence input request signals to the two information terminals of the user B. At the same time, the information terminal 1 transmits presence input request signals including information to the effect that presence input by the user B is requested to the information terminals of the users C and D.

As described above, when input request signals for a presence of the user B is transmitted not only to the two information terminals of the user B but also to the information terminals of the users C and D, all of these information terminals display an input screen for a presence of the user B. In the event that all of the members of the user B's section are attending the same meeting and the user B is the speaker, the user B will not be able to input a presence even if his/her information terminal is displaying an input screen. In such a case, the users C and D attending the same meeting as the user B will realize that some kind of information has been received by their information terminals due to vibrator functions of the same. By viewing the input screens on the information terminals and realizing that someone has requested input of a presence of the user B, the users C and D are now able to operate their own information terminals to input the presence of the user B.

With the present embodiment, by notifying a presence input request to a plurality of information terminals owned by the presence input request target, the likelihood that the target will become aware of the presence input request increases. In addition, even if the target is in a state where a presence cannot be inputted, by notifying the presence input request to those likely to be aware of the presence of the target, it is likely that a person who is aware of the presence of the target will input the presence of the target on behalf of the target. As a result, the possibility of a presence being inputted increases.

While the identifier conversion table and the list have been arranged to be stored in the presence server 2, the information may alternatively be stored in the storage units 12 of the respective information terminals. In this case, data processing speed increases compared to a case where information terminals connect to the presence server 2 every time the identifier conversion table or the list is referenced.

In addition, while the example described above addresses a case in which the user selects any of three methods, the information terminal 1 may alternatively determine a forwarding destination of a presence input request signal based on predetermined forwarding conditions. In this case, the forwarding conditions and information on forwarding destination candidates are stored in advance in the storage unit 12. Forwarding conditions refer to conditions on how a forwarding destination is to be selected based on the respective states of the presence input request destinations. Contents of such forwarding conditions may vary among information terminals. An example of forwarding conditions will be described below.

According to these transfer conditions, when the information terminal 3 of the user B that is a transmission destination of a presence input request signal is in a logoff state in which the information terminal 3 is incapable of communication, presence input request signals are forwarded to the information terminals of the users C and D who belong to the same department as the user B. When the information terminal 1 in which these forwarding conditions are stored in advance attempts to transmit a presence input request signal to the information terminal 3, upon realizing that the information terminal 3 is in a logoff state, the information terminal 1 forwards presence input request signals requesting input of a presence of the user B to the information terminals of the users C and D who belong to the same department as the user B.

Forwarding conditions to be registered in the storage unit 12 need not be limited to one and a plurality of forwarding conditions may be registered instead. Moreover, forwarding destination candidates may differ among forwarding conditions. The control unit 13 of an information terminal selects a candidate satisfying the forwarding conditions, and forwards the presence input request signal to the selected candidate.

Furthermore, while the example described above addresses a case where a forwarding destination of a presence input request signal is determined at the presence input request source, the forwarding destination of a presence input request signal may alternatively be determined at the presence input request destination. A case will now be described where a user receiving a presence input request selects a forwarding destination. Information on a plurality of candidates to become forwarding candidates of presence input request signals are stored in advance in the storage unit 12. Upon receiving a presence input request signal, the control unit 13 causes information on the plurality of candidates to be displayed on the display unit 16, and when a forwarding destination is selected by the user from the plurality of candidates, a presence input request signal is forwarded to the selected candidate.

A case will now be described where an information terminal receiving a presence input request signal selects a forwarding destination of the signal. Information on a plurality of candidates to become forwarding candidates of presence input request signals as well as information on forwarding conditions are stored in advance in the storage unit 12. Upon receiving a presence input request signal, the control unit 13 selects a candidate satisfying the forwarding conditions from the plurality of candidates, and forwards the presence input request signal to the selected candidate.

While a description has been given using a case involving a plurality of forwarding destination candidates of a presence input request signal, only one forwarding destination candidate may be used instead.

### Third Embodiment

The present embodiment is arranged so that a call is made to another party in an attempt to contact the other party, and a presence input request is notified to the other party regardless of whether the other party answers the phone.

A configuration of an information processing system according to the present embodiment will be described below. Hereinafter, while configurations and operations which differ from those of the first embodiment will be described in detail, descriptions on configurations and operations similar to those of the first embodiment will be omitted.

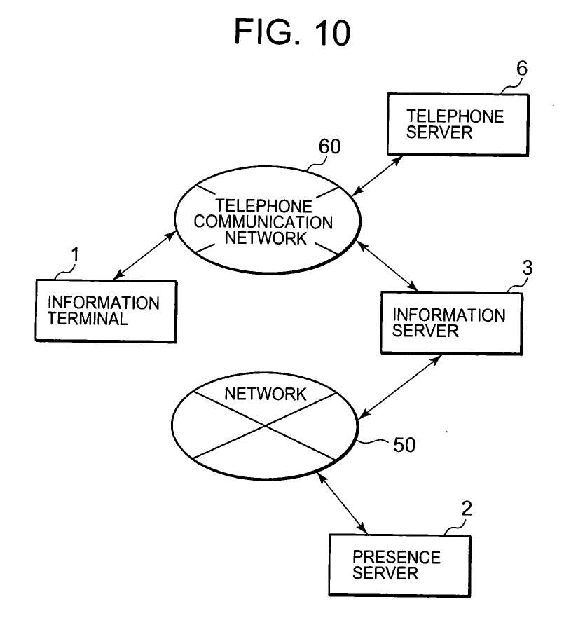

FIG. 10 is a block diagram showing a configuration example of an information processing system according to the present embodiment.

In the present embodiment, the information terminals 1 and 3 are IP telephones. The user interface unit 32 is provided with a microphone (not shown) for audio input and a speaker (not shown) for audio output. Since functions as an IP telephone are similar to ordinary IP telephones, a detailed description thereof will be omitted.

As shown in FIG. 10, the information processing system according to the present embodiment is provided with a telephone server 6 connected to a telephone communication network 60 and which provides connection between the information terminals. The information terminals 1 and 3 are connected via the telephone communication network 60 and the telephone server 6. In the present embodiment, the telephone communication network 60 is an IP telephone network.

Upon acknowledging via the communication unit 11 that a call signal requesting connection has been received from the outside, the respective request processing units 31 of the information terminals 1 and 3 notify that an incoming call was received to a user via the user interface unit 32 and also notifies that presence input is requested to the user via the user interface unit 32. This is performed because, among callers, there are those who wish to verify the current status of the user even if a connection is not made.

Notification of the incoming call to the user may be made by a vibrator operation, a ringing tone from the speaker, or the like. Notification of a presence input request to the user may be made by displaying a message requesting presence input on the display unit 16, displaying a presence input screen on the display unit 16, or the like.

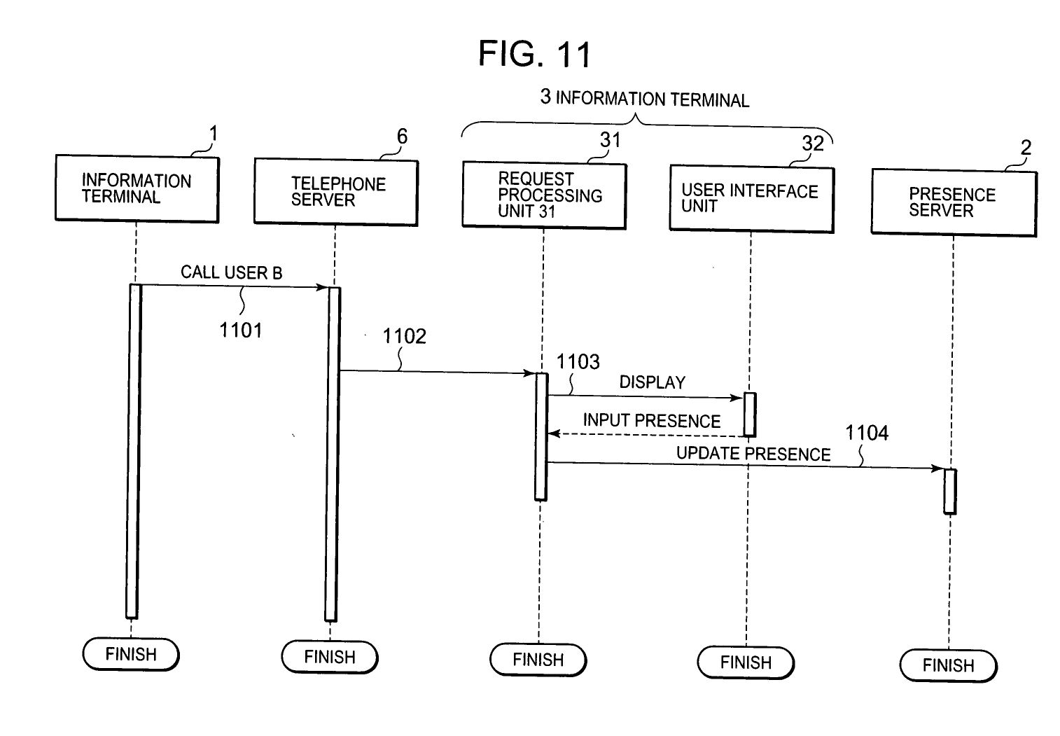

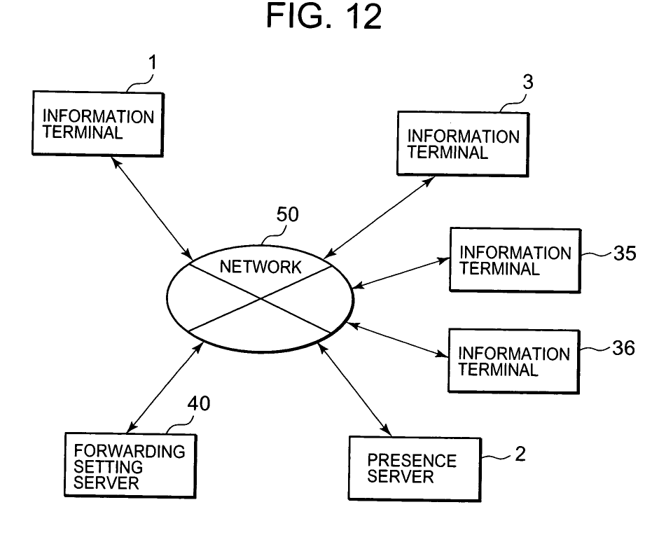

Operations of the information processing system according to the present embodiment will be described below. FIG. 11 is a flowchart showing an operation procedure of the information processing system shown in FIG. 10. In this case, it is assumed that the user A wishes to learn about the presence of the user B.

When the user A operates the information terminal 1 to call the information terminal 3 of the user B (step 1101), the telephone server 6 transmits a call signal intended for the information terminal 3 via the telephone communication network 60 to the information terminal 3 (step 1102). Upon acknowledging reception of the call signal, the request processing unit 31 of the information terminal 3 causes a presence input screen to be displayed on the display unit 16 of the user interface unit 32 (step 1103). When a presence is inputted by the user B, the request processing unit 31 transmits presence update information to the presence server 2 (step 1104).

According to the present embodiment, a presence input screen is displayed on an information terminal at the timing of an incoming call. Therefore, a user need only input a presence incidentally when noticing an incoming call and, as a result, the work load on the user is reduced compared to a case where a presence is inputted at regular time intervals. In addition, as described with reference to FIG. 7 of the first embodiment, the work load on the part of the user for inputting presence can be further reduced by having the information terminal display several presence candidates and having the user select a presence from the candidates.

While the present embodiment assumes that the telephone communication network 60 is an IP telephone network, an ordinary telephone communication network may be used instead. In addition, the information terminals 1 and 3 may be mobile telephones. In this case, a base station for performing wireless communication is provided on the telephone line network of the telephone communication network 60. Furthermore, while the telephone communication network 60 is assumed to be a-dedicated network for IP telephones, a common communication protocol may be used between the network 50 and the telephone communication network 60. In this case, the telephone communication network 60 and the network 50 need not be separately provided and the respective servers and the respective information terminals can be connected by a common network. This also applies to fourth, sixth and seventh embodiments described below.

### Fourth Embodiment

While the second embodiment is arranged so that an input request for a presence of the user B is made by the user A to users other than the user B or to other terminals of the user B as presence input request destinations, the present embodiment is arranged so that a server selects a presence input request destination.

A configuration of an information processing system according to the present embodiment will be described below. Hereinafter, while configurations and operations which differ from those of the first embodiment will be described in detail, descriptions on configurations and operations similar to those of the first embodiment will be omitted.

FIG. 12 is a block diagram showing a configuration example of an information processing system according to the present embodiment.

As shown in FIG. 12, with the information processing system according to the present embodiment, a forwarding setting server 40 is connected to the network 50 configured as shown in FIG. 2. For the present embodiment, information terminals 35 and 36 to be connected to the network 50 have been added for illustrative purposes. The information terminal 35 is a terminal carried by the user C. The information terminal 36 is a terminal carried by the user D. In addition, it is assumed that the user B belongs to the same section as the users C and D.

Upon input of a presence input request destination and an instruction requesting presence input, the request processing units 31 of the information terminals 1, 3, 35 and 36 transmit a presence input request signal including information on a terminal identifier of an information terminal that is the presence input request destination to the forwarding setting server 40 via the communication unit 11.

The identifier conversion table and the list described in the second embodiment are stored in the storage unit 22 of the presence server 2 shown in FIG. 4.

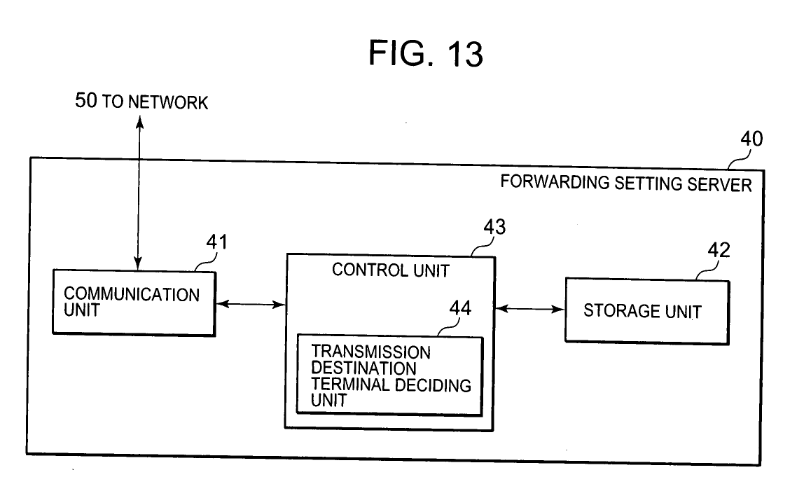

FIG. 13 is a block diagram showing a configuration example of the forwarding setting server 40 shown in FIG. 12. As shown in FIG. 13, the forwarding setting server 40 includes: a communication unit 41 that transmits and receives information to/from information terminals and the presence server 2; a storage unit 42 for storing information transmitted and received at the communication unit 41; and a control unit 43 that controls the respective units.

The control unit 43 includes a transmission destination terminal decision unit 44. The control unit 43 includes a CPU (not shown) that executes processing according to a program, and a memory (not shown) for storing the program. The execution of a program by the CPU causes the transmission destination terminal decision unit 44 to be virtually-constructed inside the forwarding setting server 40.

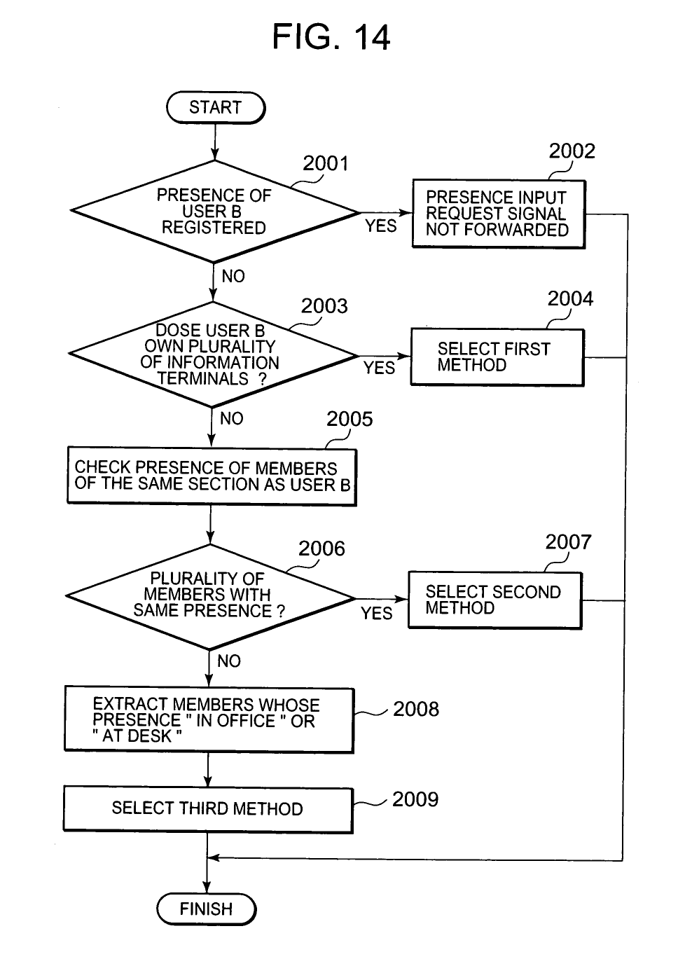

Upon receiving a presence input request signal from an information terminal via the communication unit 41, in accordance with a predetermined algorithm, the transmission destination terminal decision unit 44 decides on any one of four methods including, in addition to the three methods described in the second embodiment, a case where a presence input request signal is sent to neither of the terminals. Various algorithms are conceivable as the algorithm for selecting one method from the four methods. For now, an example of such a method will be described. FIG. 14 is a flowchart showing an example of an operation procedure of a transmission destination terminal decision unit. In this case, it is assumed that the user A is to request presence input to the user B.

Upon receiving a presence input request signal to the user B, the transmission destination terminal decision unit 44 checks whether a presence of the user B is registered in the presence server (step 2001). When a presence has been registered, the processing is terminated because there is no need to request presence input (step 2002).

When a presence of the user B has not been registered in step 2001, the transmission destination terminal decision unit 44 connects to the presence server 2 to reference the identifier conversion table stored in the storage unit 22, and checks whether the user B owns a plurality of information terminals (step 2003). In the case where the user B owns a plurality of information terminals, the first method described in the second embodiment is performed (step 2004).

In the case where the user B does not own a plurality of information terminals in step 2003, the transmission destination terminal decision unit 44 connects to the presence server 2 to reference the list stored in the storage unit 22, and checks for members of the same section as the user B (step 2005). Subsequently, the transmission destination terminal decision unit 44 checks the schedule of members belonging to the same section as the user B from information in the storage unit 22 of the presence server 2, and checks whether there are two or more members whose presences have the same contents (step 2006). When there are two or more members whose presences are the same, the second method described in the second embodiment is performed on the two or more members (step 2007). This is based on a judgment that the user B is likely to be in the company with the two or more members.

A specific example will be described below. Assuming that the user C and the user D share the same presence of “in meeting”, the transmission destination terminal decision unit 44 transmits a presence input request signal including information requesting presence input by the user B to the information terminals 35 and 36 shown in FIG. 12. Assuming that the user B is attending the same meeting as the users C and D, the user C or the user D should naturally be aware of the presence of the user B. Furthermore, even if the user B is speaking at the meeting, the user C or the user D will be able to input the presence of the user B. After the user D operates the operating unit 17 of the information terminal 36 to input a presence of the user B, the request processing unit 31 of the information terminal 36 transmits presence update information on the user B to the presence server 2.

After the user D operates the information terminal 36 to input a presence as described above, the input screen on the information terminal 35 of the user C may be erased in the following manner. The information terminal 36 transmits an input completion signal indicating that an input of a presence-had been performed to the forwarding setting server 40. Upon receiving an input completion signal from the information terminal 36, the forwarding setting server 40 transmits an input screen erasing signal for instructing erasure of the input screen to the information terminal 35. Upon receiving an input screen erasure signal from the forwarding setting server 40, the information terminal 35 erases the input screen on the display unit 16. Instead of erasing the input screen with an external signal, the input screen may remain displayed until the user C himself/herself operates the information terminal 35 and erases the input screen. Moreover, while members of the same section as the user B are targeted in step 2005, a target need not belong to the same “section” as long as the target belongs to the same organization as the user B.

In the case where two or more members having the same presence do not exist in step 2006 in FIG. 14, members of the same section as the user B whose presence is either “in office” or “at desk” are extracted (step 2008). Subsequently, the third method described in the second embodiment is performed on the information terminals of the extracted members and on the information terminal of the user B (step 2009). This is based on a judgment that members belonging to the same section as the user B and who are seated at their desks are likely to be aware of the current status of other members. If input of a presence of the user B is requested to someone who is out of the office or in a meeting, it is likely that the person will not be aware of the current status of the user B unless the person is in the company of the user B. In addition, even if the person is aware of the current status of the user B, the person will likely be in a situation in which it is difficult to input a presence.

The steps 2001, 2003 and 2006 of the flowchart shown in FIG. 14 respectively correspond to the forwarding conditions described in the second embodiment.

In addition to achieving the same effects as the second embodiment, the present embodiment eliminates the need to have the user select a present input request destination. Therefore, the effort of the user to be on the present input request source-side is reduced.

Information terminals may be provided with the functions of the forwarding setting server 40 according to the present embodiment. As described in the second embodiment, an information terminal that is the presence input request source may be provided with the functions of the forwarding setting server 40, and/or an information terminal that is the presence input request destination may be provided with the functions of the forwarding setting server 40. Furthermore, while a description for the present embodiment has been similarly given using a case involving a plurality of forwarding destination candidates of a presence input request signal, only one forwarding destination candidate may be used instead.

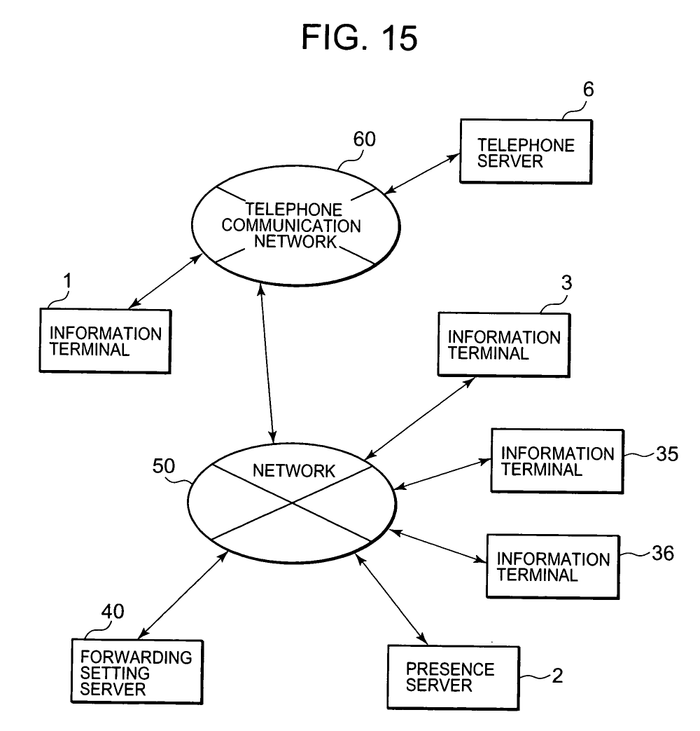

Moreover, by combining the third embodiment with the present embodiment, the transmission destination terminal decision unit 44 of the forwarding setting server 40 may be arranged to operate as described above when the user A makes a call to the user B. FIG. 15 is a block diagram showing another configuration example of the information processing system according to the present embodiment.

As shown in FIG. 15, the information terminal 1 is connected to the telephone server 6 via the telephone communication network 60. Upon receiving a call signal to the information terminal 3 of the user B from the information terminal 1, the telephone server 6 transmits the call signal to the information terminal 3 and the forwarding setting server 40. Upon receiving a call signal addressed to the terminal identifier of the information terminal 3, the transmission destination terminal decision unit 44 of the forwarding setting server 40 acknowledges that the signal is a presence input request signal to the user B. Since subsequent operations are the same as those described above, a detailed description thereof will be omitted.

In the configuration shown in FIG. 15, by merely calling the user B, a presence input request with respect to the user B is notified to a plurality of information terminals of the user B and/or to persons other than the user B even if a connection is not made. As a result, the possibility of a presence of the user B being inputted increases.

### Fifth Embodiment

The present embodiment is arranged so that, when a presence is inputted to an information terminal on the side requested to input a presence, information on the presence is transmitted to an information terminal on the side that requested the presence input.

A configuration of an information processing system according to the present embodiment will be described below. Hereinafter, while configurations and operations which differ from those of the first embodiment will be described in detail, descriptions on configurations and operations similar to those of the first embodiment will be omitted.

In the present embodiment, when a presence is inputted via the operating unit 17, the respective request processing units 31 of the information terminals 1 and 3 shown in FIG. 2 transmit presence update information to the presence server 2 and, at the same time, transmit information on the presence to the transmission source of the presence input request signal.

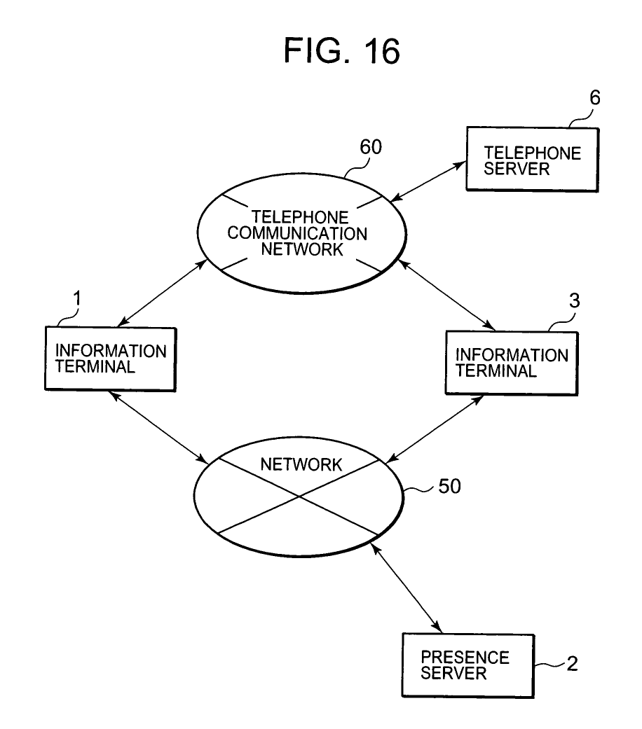

As shown in FIG. 16, in the block diagram shown in FIG. 10 and described in the second embodiment, the information terminal 1 may be arranged to be connected to the network 50 so that communication is established therebetween. In this case, as described above, signals transmitted by the information terminal 3 can now be received by the information terminal 1 via the network 50.

Operations of the information processing system according to the present embodiment will be described below. While the present embodiment is applicable to any of the first to fourth embodiments, a description will now be given on a case where the present embodiment is applied to the first embodiment.

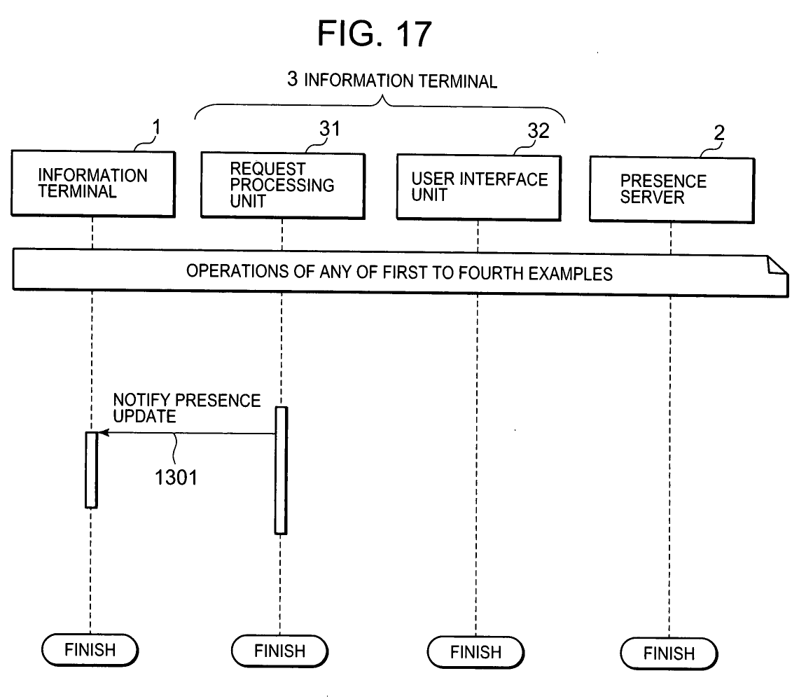

FIG. 17 is a flowchart showing operations of the information processing system according to the present embodiment.

As shown in FIG. 5, in step 1005, the request processing unit 31 of the information terminal 3 transmits presence update information to the presence server 2 and, at the same time, notifies the presence update to the information terminal 1 by transmitting information on the presence thereto (step 1301). Upon receiving presence information from the information terminal 3, the request processing unit 31 of the information terminal 1 causes the presence of the user B to be displayed on the display unit 16.

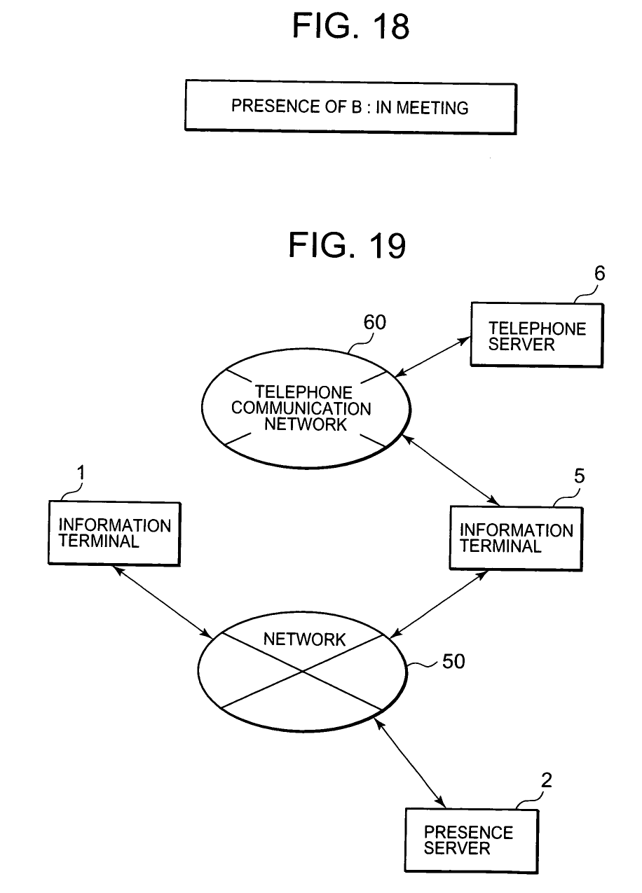

FIG. 18 is a diagram showing a display example of a presence. The screen shown in FIG. 18 indicates that the user B is “in meeting”. While a case has been shown in which a presence is displayed on the display unit 16, a speaker (not shown) may be provided at the user interface unit 32 whereby a presence of the user B is outputted as audio through the speaker.

With the present embodiment, since a presence is displayed as a response to a presence request on an information terminal of a user that is a presence input request source, it is now possible to learn a presence at an earlier timing.

### Sixth Embodiment

The present embodiment is arranged so that, when a presence is inputted by a user was requested to input a presence, an answering machine or call forwarding of the user's telephone is set.

A configuration of an information processing system according to the present embodiment will be-described below. Hereinafter, while configurations and operations which differ from those of the first embodiment will be described in detail, descriptions on configurations and operations similar to those of the first embodiment will be omitted.

FIG. 19 is a block diagram showing a configuration example of an information processing system according to the present embodiment.

As shown in FIG. 19, in the information processing system according to the present embodiment, information terminals 1, 5 and the presence server 2 are connected via the network 50 so as to be capable of communicating with each other. In addition, the information terminal 5 is connected to the telephone server 6 via the telephone communication network 60 that is an IP telephone network. The information terminal 5 is a terminal carried by the user B.

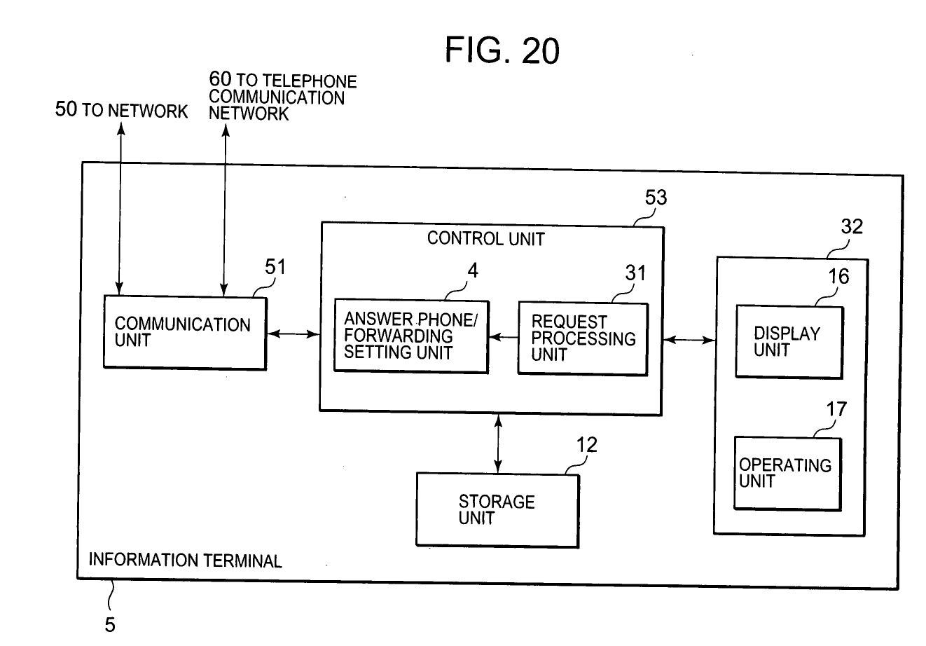

A configuration of the information terminal 5 carried by the user B will now be described. FIG. 20 is a block diagram showing a configuration example of the information terminal 5. Configurations similar to those of the information terminal 3 are assigned like reference numerals and a detailed description thereof shall be omitted.

In the present embodiment, the information terminal 5 is an IP telephone. The user interface unit 32 is provided with a microphone (not shown) for audio input and a speaker (not shown) for audio output. Since functions as an IP telephone are similar to ordinary IP telephones, a detailed description thereof will be omitted.

As shown in FIG. 20, the information terminal 5 includes a communication unit 51; a storage unit 12; the user interface unit 32; and a control unit 53. The control unit 53 includes a request processing unit 31 and an answering machine/forwarding setting unit 4. The control unit 53 includes a CPU (not-shown) that executes processing according to a program, and a memory (not shown) for storing the program. The execution of a program by the CPU causes the request processing unit 31 and the answering machine/forwarding setting unit 4 to be virtually-constructed inside the information terminal. An answering machine/forwarding setting rule indicating what kind of processing is to be performed on a presence inputted via the user interface unit 32 is registered in the storage unit 12.

When a presence is inputted via the user interface unit 32, the request processing unit 31 transmits the presence to the presence server 2 via the communication unit 51 and, at the same time, hands over the presence to the answering machine/forwarding setting unit 4. If a presence ending time or a presence remaining time has been inputted, such information is also handed over to the answering machine/forwarding setting unit 4.

Upon receiving the presence from the request processing unit 31, the answering machine/forwarding setting unit 4 decides how answering machine/forwarding should be set with respect to the received presence in accordance with the answering machine/forwarding setting rule. Subsequently, the answering machine/forwarding setting unit 4 transmits answering machine/forwarding setting information that is information regarding an answering machine/forwarding setting to the telephone server 6. A specific example of the answering machine/forwarding setting rule will now be described.

In the case of a presence of “out of office” or “on break”, answering machine/forwarding setting information is generated to the effect that an answering machine is being set so as to have the caller leave a message because the user is unable to answer the phone. In the case of a presence of “in meeting”, answering machine/forwarding setting information is generated to the effect that call forwarding to a telephone at the office is being set to have another member of the office answer the phone in place of the user because the user himself/herself is unable to do so. If a presence ending time or a presence remaining time has been inputted, information for causing the answering machine setting or forwarding setting to be terminated in association with the conclusion of the presence is inserted into the answering machine/forwarding setting information. Furthermore, if a presence ending time or a presence remaining time has not been inputted, information on a predetermined validity period is inserted into the answering machine/forwarding setting information so that the setting is enabled only during the validity period.

The user may modify contents of the answering machine/forwarding setting rule by operating the operating unit 17 of the user interface unit 32. In addition, as a measure against cases where a presence ending time and a presence remaining time have not been inputted, the user inputs a validity period of an answering machine/forwarding setting in the event that neither a presence ending time nor a presence remaining time is inputted when inputting a presence, whereby the validity period is set as a default value. Information on the validity period is also stored in the storage unit 12.

In addition to the information terminal of the user B, the information terminal 1 of the user A may also be configured similar to the information terminal 5.

A description will now be given on the telephone server 6. Upon receiving answering machine/forwarding setting information from the information terminal 5, the telephone server 6 saves the answering machine/forwarding setting information in a storage unit (not shown) together with a terminal identifier of the information terminal 5 that is the transmission source of the information. In addition, upon receiving a call signal, the telephone server 6 checks whether answering machine/forwarding setting information is saved inside the storage unit. In this case, since answering machine/forwarding setting information regarding the information terminal 5 has been saved, the telephone server 6 checks whether the call signal is intended for the information terminal 5. If the call signal is intended for the information terminal 5, handling of an answering machine or forwarding of the call signal is performed according to the answering machine/forwarding setting information.

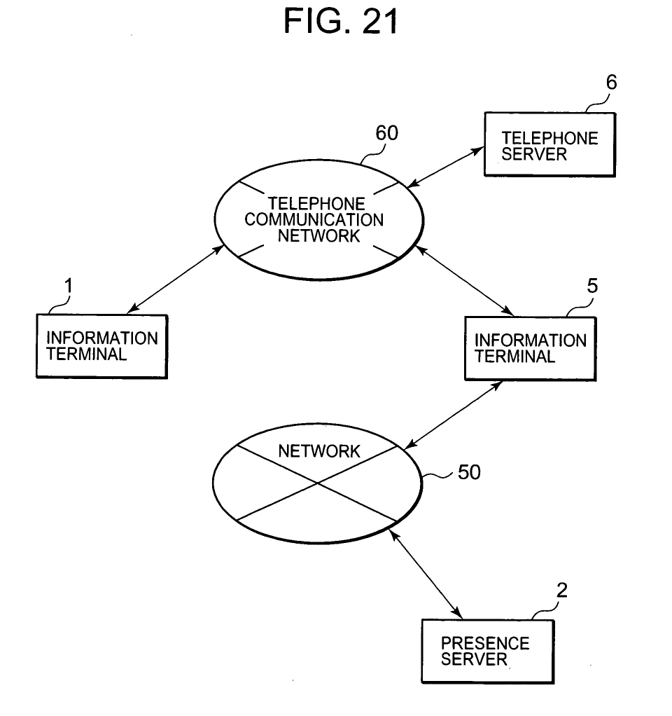

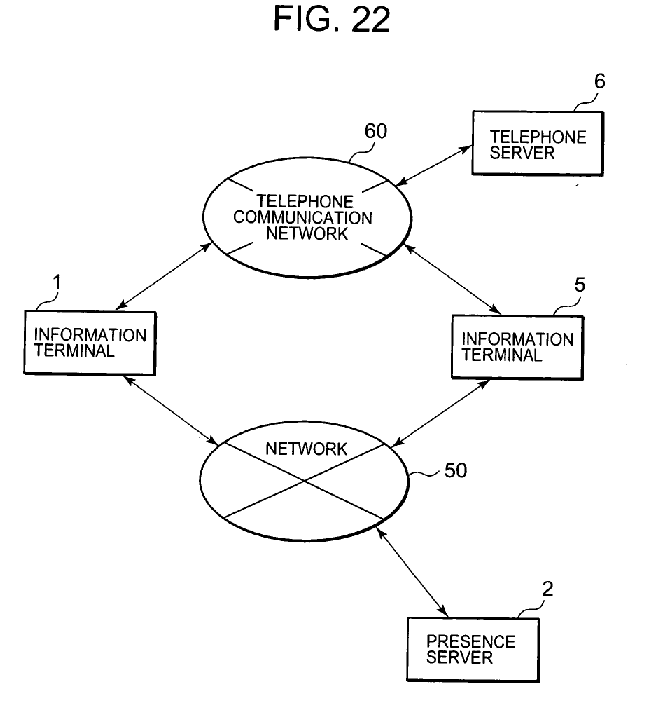

While a description has been given using a case where the present embodiment is applied to the first embodiment, the present embodiment may instead be applied to each of the second to fifth embodiments. FIG. 21 is a block diagram showing a case where the information processing system according to the present embodiment is applied to the third embodiment. FIG. 22 is a block diagram showing a case where the information processing system according to the present embodiment is applied to the fifth embodiment.

As shown in FIG. 21, the information terminal 3 shown in FIG. 10 has been replaced with the information terminal 5. In addition, as shown in FIG. 22, the information terminal 3 shown in FIG. 16 has been replaced with the information terminal 5. Block diagrams showing configurations of the system in cases where the present embodiment is respectively applied to the second and fourth embodiments will be omitted. Since the case where the present embodiment is applied to each of the second to fifth embodiments overlaps with the aforementioned case where the present embodiment is applied to the first embodiment, descriptions thereof will be omitted.

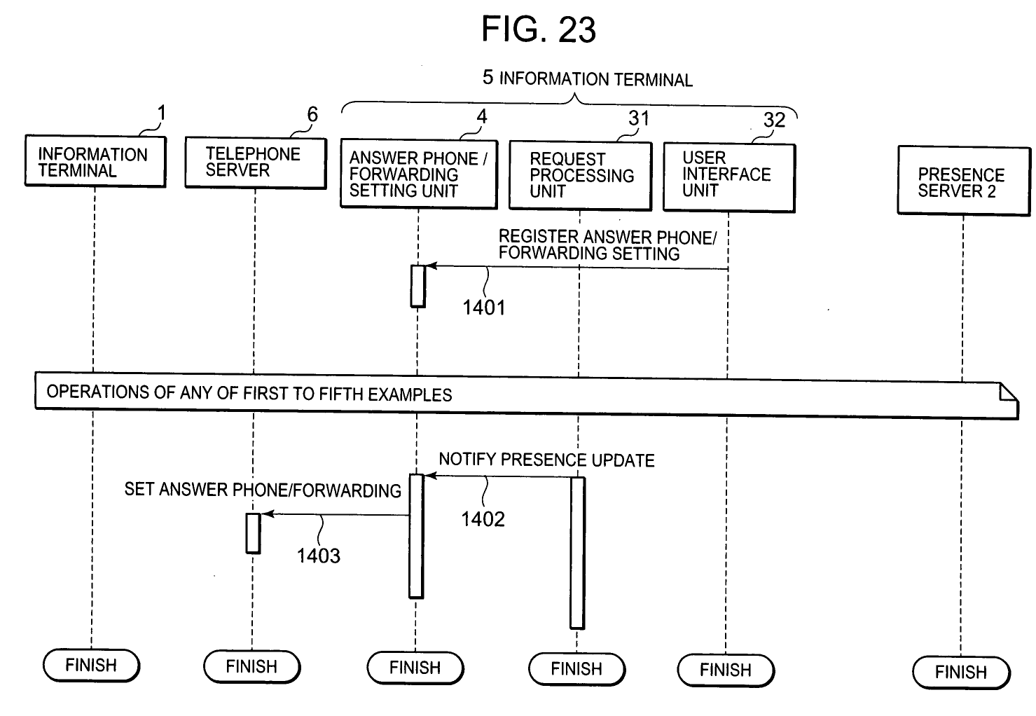

Next, an operation procedure of the information processing system according to the present embodiment will be described. FIG. 23 is a flowchart showing an operation procedure of the information processing system according to the present embodiment. A case is assumed where the user A makes a call to the user B.

As the user B operates the operating unit 17 of the information terminal 5 to input that the answering machine is to be set in the case of “out of office” or “on break” and call forwarding to a telephone in the office is set in the case of “in meeting”, the control unit 53 generates answering machine/forwarding setting information in accordance with the inputted contents and stores the same in the storage unit 12 (step 1401). In addition, it is assumed that a validity period of the setting information has been registered by an operation of the user B as a default value in the storage unit 12.

In a similar manner as in the first embodiment, it is assumed that the user A had attempted to obtain the presence of the user B from the presence server 2 by operating the information terminal 1 but the presence of the user B was not registered in the presence server 2. As the user A operates the information terminal 1 to input a request for inputting a presence to the user B, the information terminal 1 transmits a presence input request signal to the information terminal 5 via the network 50.

Upon receiving the presence input request signal from the information terminal 1, the information terminal 5 displays a presence input screen on the display unit 16. When the user B inputs “in meeting” via the operating unit 17, the information terminal 5 transmits presence update information to the presence server 2 via the network 50 (step 1402).

In addition, upon receiving the presence “in meeting” from the request processing unit 31, the answering machine/forwarding setting unit 4 transmits, to the telephone server 6, answering machine/forwarding setting information including a forwarding destination telephone number, information to the effect that calls are to be forwarded, and information on a default value to be used as a forwarding period (step 1403). In this case, since neither a presence ending time nor a presence remaining time had been inputted, the answering machine/forwarding setting unit 4 has read out the default value from the storage unit 12 and has inserted the default value into the answering machine/forwarding setting information. If an ending time or a remaining time is inputted, the inputted information is inserted into the answering machine/forwarding setting information.

The telephone server 6 stores the answering machine/forwarding setting information received from the information terminal 1 in the storage unit 12. Subsequently, upon receiving a call signal to the information terminal 5, the telephone server 6 reads out the answering machine/forwarding setting information, and upon acknowledging that call forwarding has been set, the telephone server 6 transmits a call signal to a terminal at the forwarding destination telephone number. The telephone server 6 performs call forwarding of calls made to the information terminal 5 until the validity period included in the answering machine/forwarding setting information expires.

In the present embodiment, by inputting a presence, either an answering machine or call forwarding is set in correspondence to the contents of the presence. Therefore, when it is required that either an answering machine or call forwarding is to be set during presence input, the effort of performing setting can be saved. In addition, since either an answering machine or call forwarding is set in correspondence to the contents of the presence when there is time to spare, operational errors that may occur during presence input when telephone-related settings are performed in haste can be reduced.

### Seventh Embodiment

While the sixth embodiment has been arranged so that an information terminal issues instructions for setting an answering machine or call forwarding on a telephone server, the present embodiment is configured so that a server for instructing the settings to the telephone server is separately provided.

A configuration of an information processing system according to the present embodiment will be described below. Hereinafter, while configurations and operations which differ from those of the first embodiment will be described in detail, descriptions on configurations and operations similar to those of the first embodiment will be omitted.

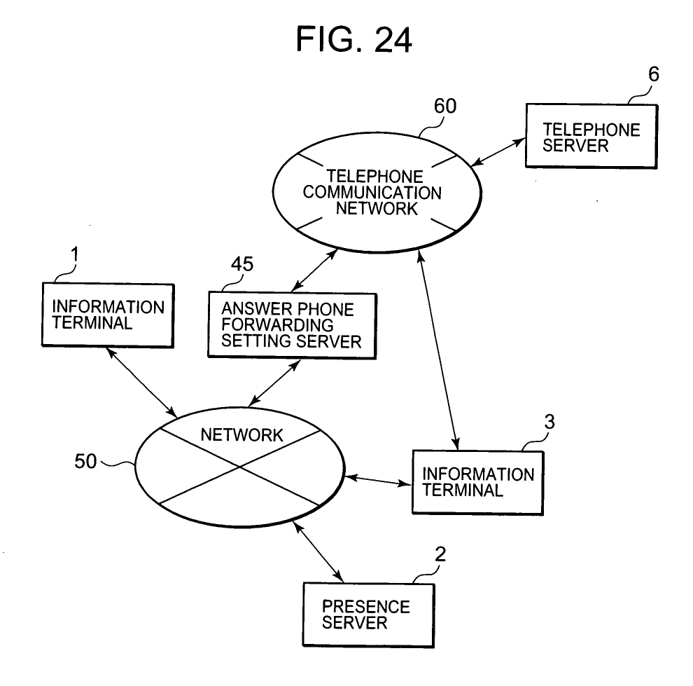

FIG. 24 is a block diagram showing a configuration example of an information processing system according to the present embodiment.

As shown in FIG. 24, in addition to the configuration shown in FIG. 2, the information processing system according to the present embodiment includes: a telephone communication network 60; a telephone server 6 connected to the telephone communication network 60; and an answering machine/forwarding setting server 45 respectively connected to the telephone communication network 60 and the network 50. The information terminal 3 carried by the user B includes IP telephone functions and is connected not only to the network 50 but also to the telephone communication network 60. When a presence is inputted via the user interface unit 32 shown in FIG. 3, the information terminal 3 transmits the presence to the presence server 2 and the answering machine/forwarding setting server 45 via the communication unit 11.

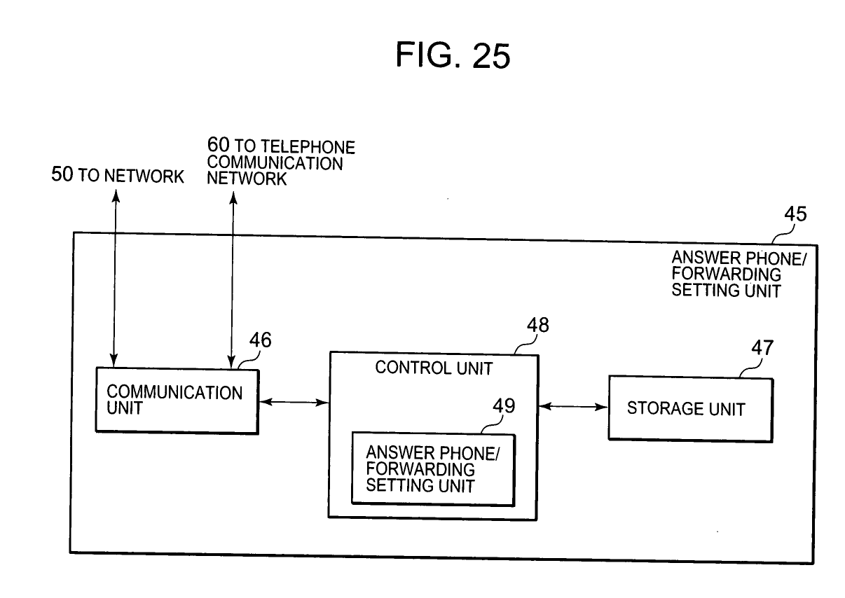

A description will now be given on the answering machine/forwarding setting server 45. FIG. 25 is a block diagram showing a configuration example of an answering machine/forwarding setting server.

As shown in FIG. 25, the answering machine/forwarding setting server 45 includes: a communication unit 46 that connects to the network 50 and to the telephone communication network 60; a storage unit 47; and a control unit 48. The control unit 48 includes an answering machine/forwarding setting unit 49.

The answering machine/forwarding setting rule described in the sixth embodiment is stored together with a terminal identifier in the storage unit 47. The terminal identifier is attached so as to enable identification of which user the setting rule is for. Since the answering machine/forwarding setting rule is similar to that described in the sixth embodiment, a detailed description thereof will be omitted.

The control unit 48 includes a CPU (not shown) that executes processing according to a program, and a memory (not shown) for storing the program. The execution of a program by the CPU causes the answering machine/forwarding setting unit 49 to be virtually-constructed inside the answering machine/forwarding setting server 45.

Upon receiving a presence from the information terminal 3 via the communication unit 46, the answering machine/forwarding setting unit 49 decides what kind of settings should be applied to the received presence based on the answering machine/forwarding setting rule, and transmits answering machine/forwarding setting information that is information related to the answering machine/forwarding setting to the telephone server 6. The answering machine/forwarding setting rule is inputted and also updated via the information terminal 3 by the user B by operating the information terminal 3 and causing the information terminal 3 to be connected to the answering machine/forwarding setting server 45.

In the present embodiment, operations described in the sixth embodiment with respect to processing in the case where an ending time or a remaining time of the answering machine/forwarding setting has been inputted or to processing for setting a validity period as a default value in the case where neither an ending time nor a remaining time has been inputted are to be performed by the answering machine/forwarding setting unit 49, and a detailed description thereof shall be omitted. The default value is stored together with the answering machine/forwarding setting rule in the storage unit 47.

In addition to the information terminal of the user B, the information terminal 1 of the user A may also be configured similar to the information terminal 3. Furthermore, since the telephone server 6 is configured similar to the sixth embodiment, a detailed description thereof shall be omitted.

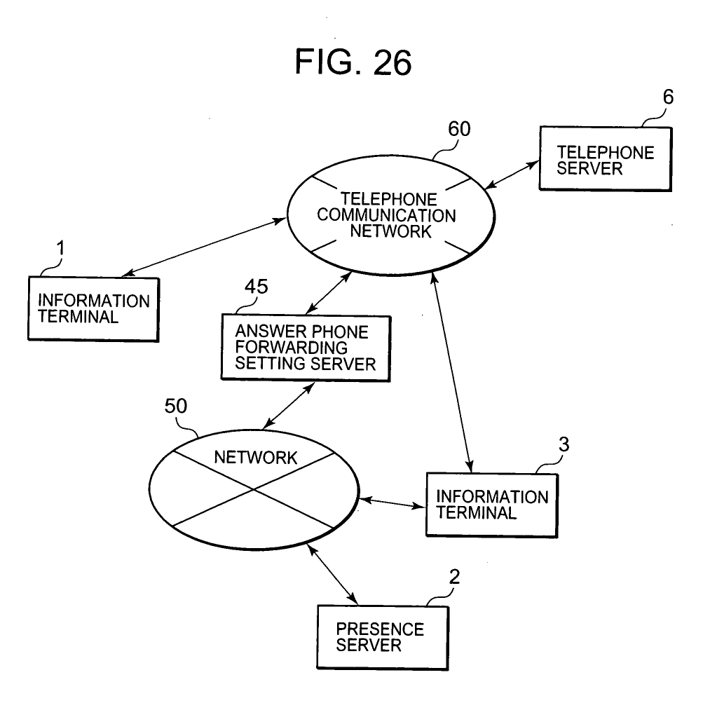

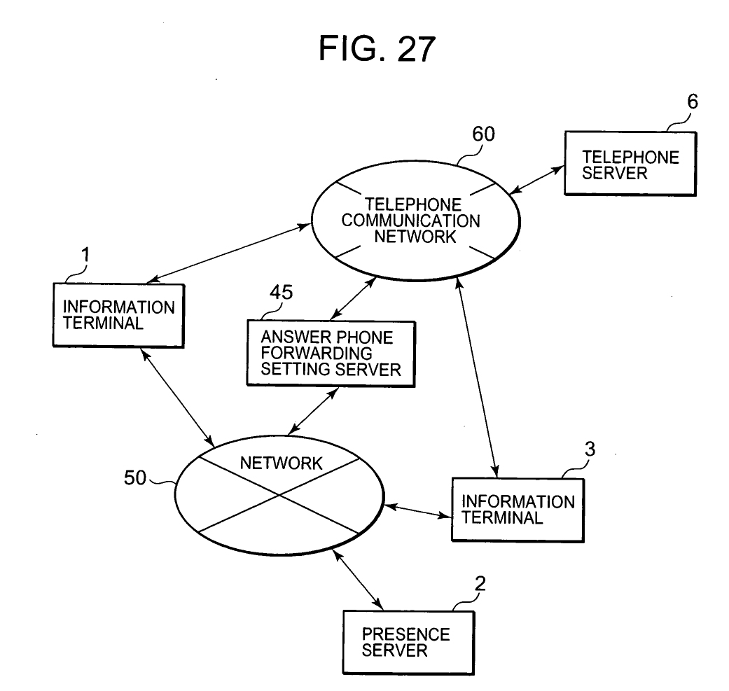

While a description has been given using a case where the present embodiment is applied to the first embodiment, the present embodiment may instead be applied to each of the second to fifth embodiments. FIG. 26 is a block diagram showing a case where the information processing system according to the present embodiment is applied to the third embodiment. FIG. 27 is a block diagram showing a case where the information processing system according to the present embodiment is applied to the fifth embodiment.

As shown in FIG. 26, the answering machine/forwarding setting server 45 has been added to the configuration shown in FIG. 10. In addition, as shown in FIG. 27, the answering machine/forwarding setting server 45 has been added to the configuration shown in FIG. 16. Block diagrams showing configurations of the system in cases where the present embodiment is respectively applied to the second and fourth embodiments will be omitted. Since cases where the present embodiment is applied to each of the second to fifth embodiments overlaps with the aforementioned case where the present embodiment is applied to the first embodiment, descriptions thereof will be omitted.

Next, an operation procedure of the information processing system according to the present embodiment will be described. In the present embodiment, a case is assumed where the user A makes a call to the user B.

The user B operates the operating unit 17 of the information terminal 3 to cause the information terminal 3 to connect to the answering machine/forwarding setting server 45. As the user B inputs an answering machine/forwarding setting rule in which the answering machine is to be set in the case of “out of office” or “on break” and call forwarding to a telephone in the office is set in the case of “in meeting”, the information terminal 3 transmits information on the setting rule to the answering machine/forwarding setting server 45. Upon receiving the answering machine/forwarding setting rule from the information terminal 3, the answering machine/forwarding setting server 45 saves the setting rule together with a terminal identifier of the information terminal 3 in the storage unit 47. In addition, a validity period of the setting information is saved in the storage unit 47 together with the answering machine/forwarding setting rule by an operation of the user B.

In a similar manner as in the first embodiment, it is assumed that the user A had attempted to obtain the presence of the user B from the presence server 2 by operating the information terminal 1 but the presence of the user B was not registered in the presence server 2. As the user A operates the information terminal 1 to input a request for inputting a presence to the user B, the information terminal 1 transmits a presence input request signal to the information terminal 3 via the network 50.

Upon receiving the presence input request signal from the information terminal 1, the information terminal 3 displays a presence input screen on the display unit 16. When the user B inputs “in meeting” via the operating unit 17, the information terminal 3 transmits presence update information to the presence server 2 via the network 50, and transmits the presence to the answering machine/forwarding setting server 45.

Upon receiving the presence “in meeting” from the information terminal 3, the answering machine/forwarding setting server 45 transmits, to the telephone server 6, answering machine/forwarding setting information including a forwarding destination telephone number, information to the effect that calls are to be forwarded, and information on the default value to be set as a forwarding period. In this case, since neither a presence ending time nor a presence remaining time had been inputted, the answering machine/forwarding setting unit 49 has read out the default value from the storage unit 47 and inserted the default value into the answering machine/forwarding setting information. If an ending time or a remaining time is inputted, the inputted information is inserted into the answering machine/forwarding setting information. Since subsequent operations are the same as those of the sixth embodiment, a detailed description thereof will be omitted.

According to the present embodiment, instead of providing an answering machine/forwarding setting unit at each information terminal, by providing a server including functions of the setting unit and unifying processing to be executed by each information terminal to the server, overall system cost can be reduced compared to a case where the setting unit is provided at each information terminal. In addition, it is also possible to reduce processing load at each of the information terminals.

### Eighth Embodiment

The present embodiment is arranged so that a predetermined presence is transmitted to the presence server in the case where a user does not input a presence within a predetermined period of time despite receiving a presence input request.

Configurations of the information processing system according to the present embodiment will be described below with reference to FIGS. 2 and 3. Hereinafter, configurations that differ from those of the first embodiment will be described in detail, and descriptions on configurations similar to those of the first embodiment will be omitted.

A display period of a presence input screen and presence information to be set when a presence is not inputted even after the display period has elapsed are stored in the storage unit 12. Since the presence is to be set when there is no input, the presence shall hereinafter be referred to as a presence on non-input.

As a user inputs the display period of the presence input screen via the operating unit 17, the request processing unit 31 saves the display period in the storage unit 12. In addition, as the user inputs via the operating unit 17 a presence to be set when a presence is not inputted while the presence input screen is being displayed, the request processing unit 31 registers the presence as a presence on non-input to the storage unit 12 together with information on the display period.

The control unit 13 includes: a signal generating circuit (not shown) which generates clock signals; and a counter circuit (not shown) which counts inputted clock signals to measure time, and notifies the time to the request processing unit 31. Upon receiving a presence input request signal, the request processing unit 31 reads out a display period stored in the storage unit 12 and information on the presence input screen, and causes the display unit 16 to display the presence input screen at the time. Subsequently, if a presence has not been inputted during the display period of the presence input screen, the control unit 13 reads out the presence on non-input from the storage unit 12 and transmits presence update information including information on the presence to the presence server 2. In addition, the control unit 13 causes the display unit 16 to erase the presence input screen.

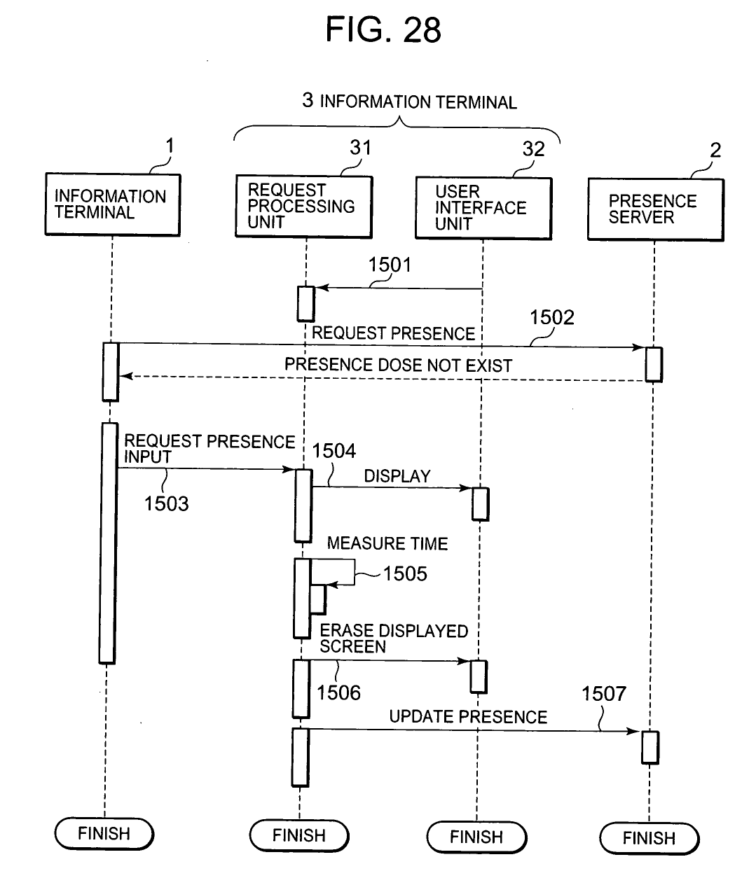

Next, an operation procedure of the information processing system according to the present embodiment will be described. FIG. 28 is a flowchart showing an operation procedure of the information processing system according to the present embodiment. Hereinafter, operations performed in addition to those of the first embodiment will be described in detail, and descriptions on portions similar to those of the first embodiment will be omitted.

The user B operates the information terminal 3 in advance, and saves a display period of the presence input screen and information on a presence on non-input in the storage unit 12 (step 1501).

In a similar manner as in the first embodiment, it is assumed that the user A had attempted to obtain the presence of the user B from the presence server 2 by operating the information terminal 1 but the presence of the user B was not registered in the presence server 2 (step 1502). As the user A operates the information terminal 1 to input a request for inputting a presence to the user B, the information terminal 1 transmits a presence input request signal to the information terminal 3 via the network 50 (step 1503).

Upon receiving the presence input request signal from the information terminal 1, the request processing unit 31 of the information terminal 3 reads out the presence input screen and display period information and causes the presence input screen to be displayed on the display unit 16 (step 1504). Time measurement is commenced from a time of day notified from the counter circuit (not shown) at this point (step 1505). If a presence is not inputted after the display period has elapsed, the request processing unit 31 causes the display unit 16 to erase the presence input screen (step 1506). Subsequently, the request processing unit 31 information reads out information on the presence on non-input from the storage unit 12 and transmits presence update information for updating to the presence to the presence server 2 (step 1507).

While the presence input screen display period is registered in advance by the user B by operating the information terminal 3 in step 1501, the presence input screen display period may alternatively be included in the presence input request signal from the information terminal 1 to be extracted and used by the request processing unit 31. In addition, the presence input screen display period may be arranged to be stored in a server on the network, whereby the request processing unit 31 acquires and uses the presence input screen display period upon activation or the like of the information terminal 3. Furthermore, when transmitting the presence update information to the presence server 2 in step 1507, the request processing unit 31 may cause the display unit 16 to display that the presence on non-input has been set.

With the present embodiment, since a presence to be set when a presence cannot be inputted is registered in advance, even when the side that was requested to input a presence does not input a presence, the side that had requested the presence input is able to verify a presence.

In addition, since a presence registered in advance is to be set if a presence is not inputted in a certain period of time after presence input is requested, the side that had requested the presence input is no longer required to wait indefinitely for presence input by the other party.

While a description has been given using a case where the present embodiment is applied to the first embodiment, the present embodiment may instead be applied to each of the second to seventh embodiments.

### Ninth Embodiment

While the eighth embodiment has been arranged so that, if a presence is not inputted, a predetermined presence is transmitted to a presence server and a presence input screen is displayed, the present embodiment is arranged so that the presence input screen remains displayed. The present embodiment is a-case where the eighth embodiment is applied to the first embodiment, and configurations and operations which differ from the eighth embodiment will be described in detail with reference to FIGS. 2 and 3.

In the present embodiment, the request processing unit 31 reads out a presence on non-input from the storage unit 12, and even when the request processing unit 31 transmits presence update information including information on the presence to the presence server 2, the request processing unit 31 causes a presence input screen to be displayed on the display unit 16 until either a presence is inputted or an instruction for erasing the presence input screen is issued via the operating unit 17.

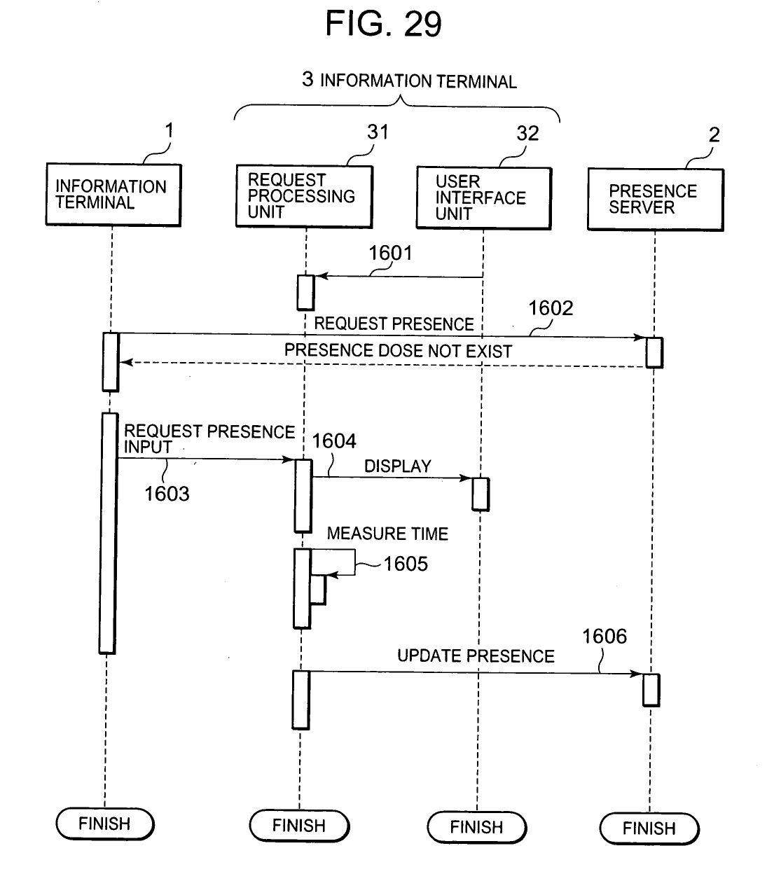

Next, an operation procedure of the information processing system according to the present embodiment will be described. FIG. 29 is a flowchart showing an operation procedure of the information processing system according to the present embodiment. Hereinafter, operations that differ from those of the first embodiment will be described in detail, and descriptions on portions similar to those of the first embodiment will be omitted.

The user B operates the information terminal 3 in advance, and saves a presence input screen display period and information on a presence on non-input in the storage unit 12 (step 1601).

In a similar manner as in the first embodiment, it is assumed that the user A had attempted to obtain the presence of the user B from the presence server 2 by operating the information terminal 1 but the presence of the user B was not registered in the presence server 2 (step 1602). As the user A operates the information terminal 1 to input a request for inputting a presence to the user B, the information terminal 1 transmits a presence input request signal to the information terminal 3 via the network 50 (step 1603).

Upon receiving the presence input request signal from the information terminal 1, the request processing unit 31 of the information terminal 3 reads out the presence input screen and display period information and causes the presence input screen to be displayed on the display unit 16 (step 1604). Time measurement is commenced from a time of day notified from the counter circuit (not shown) at this point (step 1605). If a presence is not inputted after the display period has elapsed, the request processing unit 31 information reads out information on the presence on non-input from the storage unit 12 and transmits presence update information for updating to the presence to the presence server 2 (step 1606). The request processing unit 31 causes the presence input screen to be displayed on the display unit 16 until either a presence is inputted or an instruction for erasing the presence input screen is issued via the operating unit 17.

With the present embodiment, although a presence registered in advance is to be set if a presence is not inputted after a lapse of a certain period of time, since a presence input request is continuously displayed on a terminal on the side that was requested to input a presence, the likelihood of the side that was requested to input a presence inputting a presence increases. Since a tentative presence can be first verified, the side that had requested presence input no longer needs to wait indefinitely for presence input, and the likelihood that a proper presence can be verified afterwards increases.

While the presence input screen display period is registered in advance by the user B by operating the information terminal 3 in step 1601, the presence input screen display period may alternatively be included in the presence input request signal from the information terminal 1 to be extracted and used by the request processing unit 31. In addition, the presence input screen display period may be arranged to be stored in a server on the network, whereby the request processing unit 31 acquires and uses the presence input screen display period upon activation or the like of the information terminal 3. Furthermore, while differences from the eighth embodiment have been described for the present embodiment, contents of the present embodiment may be combined with applications of the eighth embodiment to each of the first to seventh embodiments.

### Tenth Embodiment

While the eighth and ninth embodiments have been arranged so that a predetermined presence is transmitted to the presence server if a user does not input a presence within a predetermined period of time after receiving a presence input request, there is a problem in that when a predetermined presence is transmitted to the presence server, there may be cases where the presence information is incorrect as presence information of the user. The present embodiment is arranged so as to limit the use of the information terminal being used by the user when the user does not input a presence within a predetermined period of time.

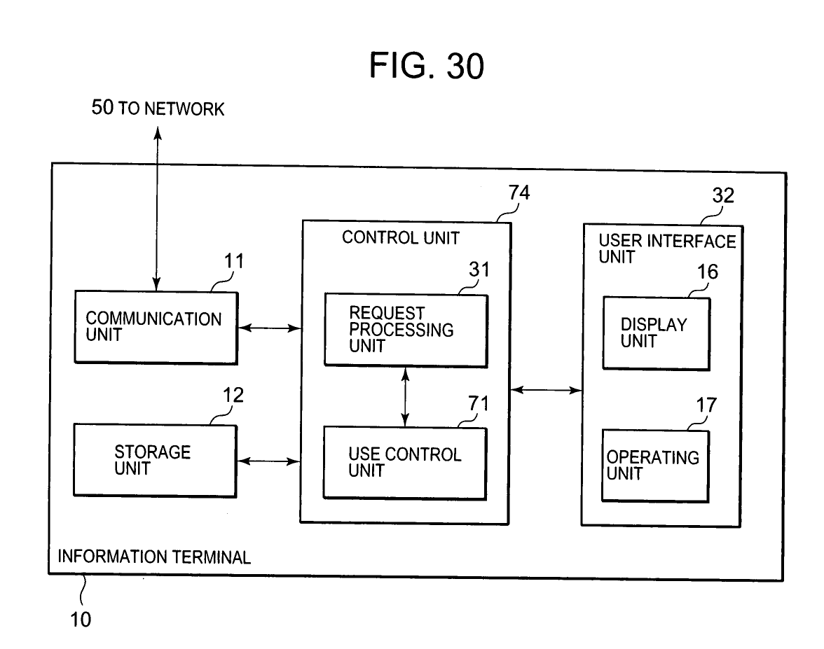

A configuration of an information terminal according to the present embodiment will be described with reference to FIG. 30. Hereinafter, configurations that differ from those of the eighth and ninth embodiments will be described in detail, and descriptions on configurations similar to those of the eighth and ninth embodiments will be omitted.

A use control unit 71 limits the use of an information terminal by controlling a display unit 76. More specifically, the use control unit 71 suppresses operations other than presence input by executing a forced logoff of the terminal while enabling presence input or by gradually darkening areas of the display unit other the presence input screen.

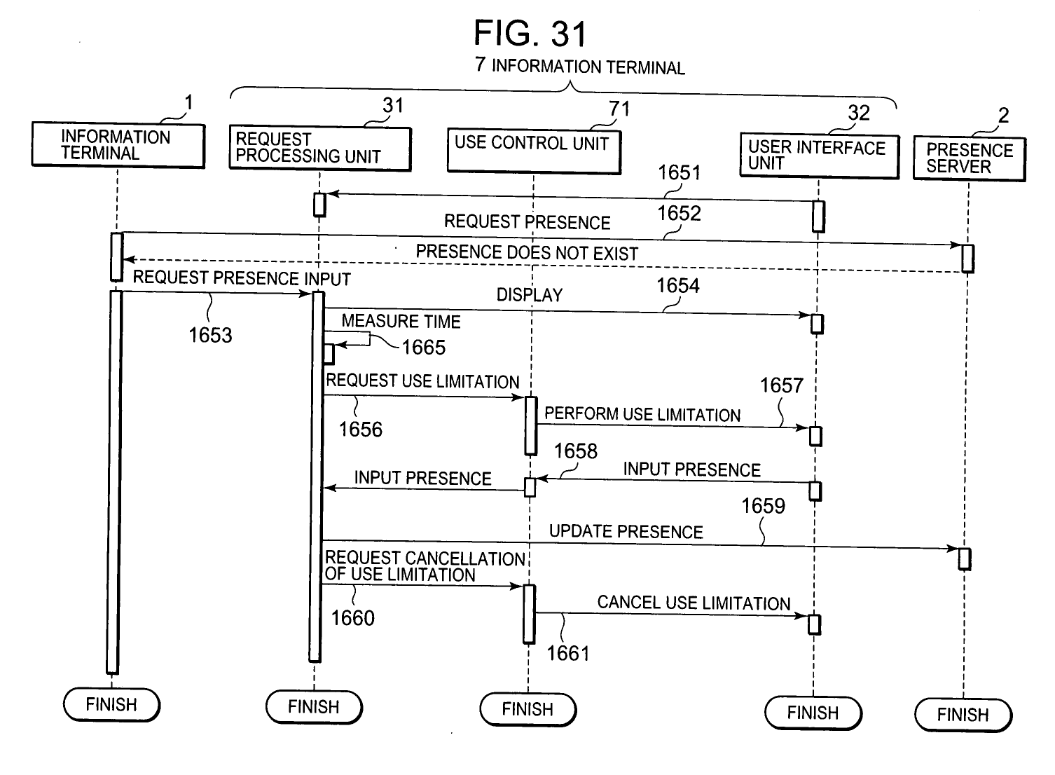

Next, an operation procedure of the information processing system according to the present embodiment will be described. FIG. 31 is a flowchart showing an operation procedure of the information processing system according to the present embodiment. Here, operations performed in addition to those of the eighth and ninth embodiments will be described in detail, and descriptions on portions similar to those of the eighth and ninth embodiments will be omitted.

The user B operates an information terminal 7 in advance, and saves information on a presence input screen display period in the storage unit 12 (step 1651).

In the same manner as in the eighth embodiment, the user A attempts to obtain a presence of the user B by operating the information terminal 1. When a presence of the user B is not registered in the presence server 2 (step 1652), the user A operates the information terminal 1 to request input of a presence to the user B. The information terminal 1 transmits a presence input request signal to the request processing unit 31 of the information terminal 7 via the network 50 (step 1653).

Upon receiving the presence input request signal from the information terminal 1, the request processing unit 31 reads out a presence input screen and display period information from the storage unit 12 and causes the presence input screen to be displayed in the user interface unit 32 (step 1654). In addition, time measurement is commenced from a time of day notified from the counter circuit (not shown) at this point (step 1655). If a presence is not inputted even when the display period has elapsed, the request processing unit 31 requests use limitation to the use control unit 71 (step 1656). The use control unit 71 controls the user interface unit 32 so that the user is unable to perform operations other than presence input (step 1657). When doing so, explanatory information to the effect that the control will be cancelled upon input of a presence may be additionally displayed on the user interface unit 32.

As the user B operates the user interface unit 32 to input a presence (step 1658), the request processing unit 31 sends presence update information to the presence server 2 (step 1659). Furthermore, the request processing unit 31 requests cancellation of use limitation of the information terminal 7 to the use control unit 71 (step 1660), whereby the use control unit 71 cancels the use limitation imposed on the user interface unit 32 (step 1661). Consequently, the user B is able to regain use of the information terminal 7.

While the presence input screen display period is registered in advance by the user B by operating the information terminal 7 in step 1651, the presence input screen display period may alternatively be included in the presence input request signal from the information terminal 1 to be extracted and used by the request processing unit 31. In addition, the presence input screen display period may be arranged to be stored in a server on the network, whereby the request processing unit 31 acquires and uses the presence input screen display period upon activation or the like of the information terminal 7.

Besides the presence input screen display period, contents of the limitation imposed on the display unit 16 by the use control unit 71 may be defined as use limitation information to be included in the presence input request signal from the information terminal 1, whereby the request processing unit 31 retrieves and hands over the use limitation information to the use control unit 71 to be used by the same. In addition, the use limitation information may be stored in a server on the network, whereby the request processing unit 31 acquires the use limitation information from the server upon activation and hands over the information to the use control unit 71 to be used by the same.

Furthermore, presence information to be transmitted to the presence server 2 in step 1658 may be stored in advance in the storage unit 73, whereby the request processing unit 31 acquires the presence information from the storage unit 73 and performs the operation of step 1658 for transmitting the presence information to the presence server 2.

With the present embodiment, since the use of a terminal will be limited unless a presence is inputted, the user himself/herself is apt to input a presence, and presence information can be acquired which is more accurate than setting a presence registered in advance.

### Eleventh Embodiment

The present embodiment is arranged so that presence input is performed when a user who had been requested a presence from another user attempts to use services.

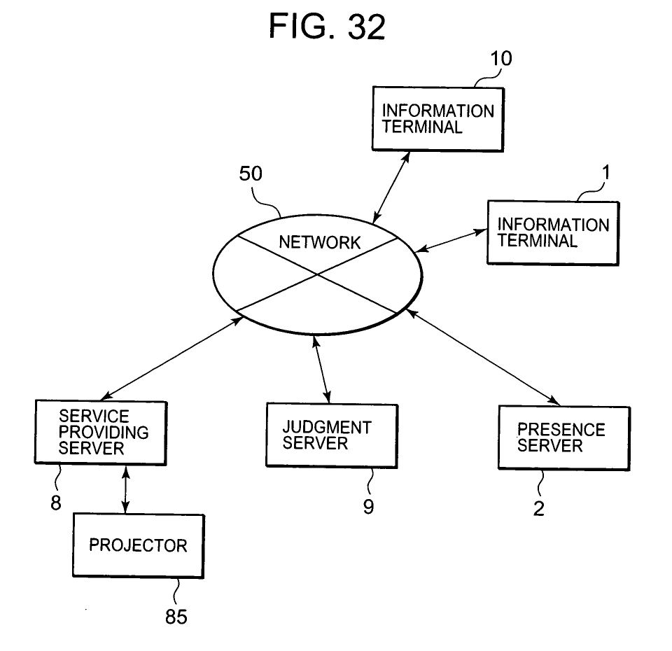

A configuration of an information processing system according to the present embodiment will be described below. FIG. 32 is a block diagram showing a configuration example of an information processing system according to the present embodiment.

As shown in FIG. 32, a service providing server 8, the information terminal 1, an information terminal 10, a judgment server 9 and the presence server 2 are connected via the network 50. A projector 85 is connected to the service providing server 8.

It is assumed that the user A is using the information terminal 1 described in the first embodiment and the user B is using the information terminal 10. When it is considered that the information terminal 1 will operate in imitation of the other examples described above, the information terminal 1 should directly transmit a presence input request to the information terminal 10. However, in the present embodiment, the information terminal 1 is arranged to transmit a presence input request to the service providing server 8.

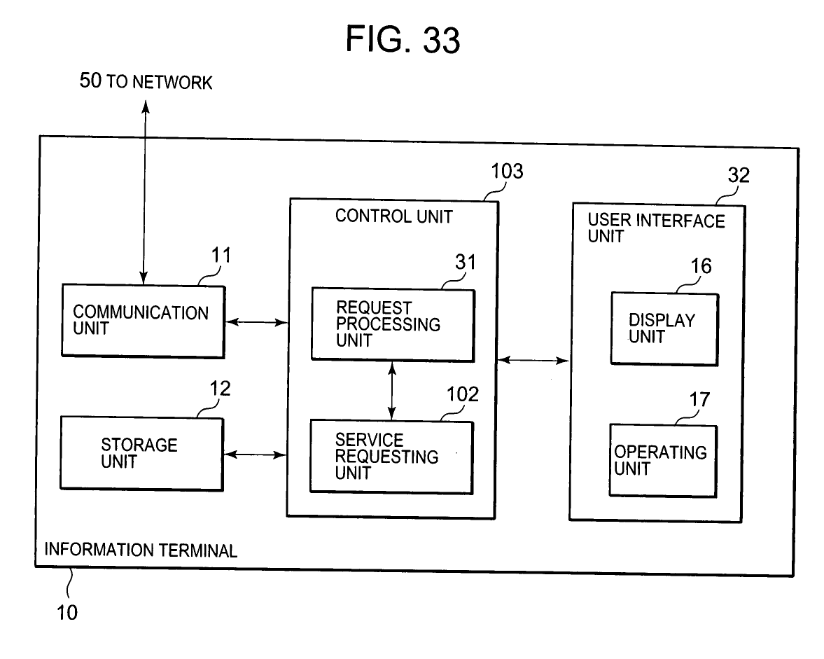

The information terminal 10 according to the present embodiment will now be described. FIG. 33 is a block diagram showing a configuration example of an information terminal according to the present embodiment.

As shown in FIG. 33, the information terminal 10 includes a communication unit 11, a storage unit 12, a control unit 103, and a user interface unit 32. The control unit 103 includes a request processing unit 31 and a service requesting unit 102. The control unit 103 includes a CPU (not shown) that executes processing according to a program, and a memory (not shown) for storing the program. The execution of a program by the CPU causes the request processing unit 31 and the service requesting unit 102 to be virtually-constructed inside the information terminal.

When a presence is inputted via the user interface unit 32, the request processing unit 31 transmits the presence to the presence server 2 via the communication unit 11 and, at the same time, notifies the service requesting unit 102 that a presence has been inputted. The service requesting unit 102 requests provision of services to the service providing server 8.

The service providing server 8 according to the present embodiment will now be described. The service providing server 8 is a server that provides services to the information terminal 10 and, for example, provides a service in which an electronic file supplied by the information terminal 10 is displayed at a large magnification on the projector 85.

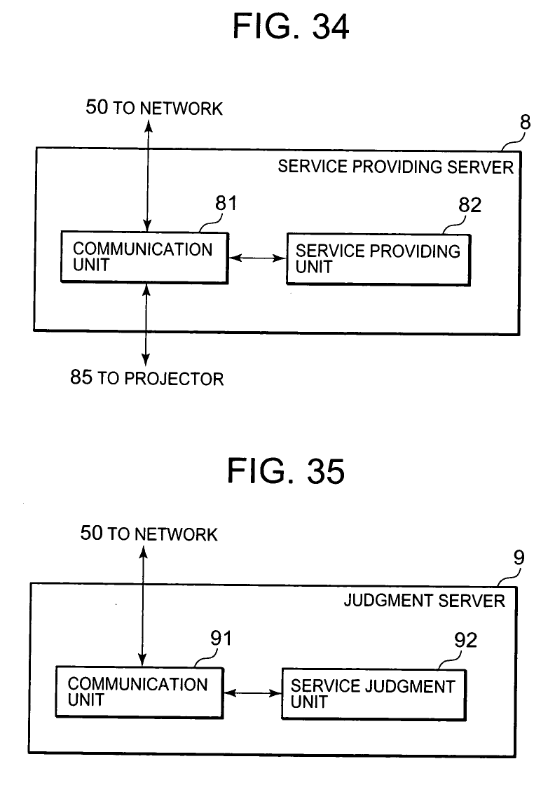

FIG. 34 is a block diagram showing a configuration example of the service providing server. As shown in FIG. 34, the service providing server 8 includes: a communication unit 81 that communicates with an external device via the projector 85 and the network 50; and a service providing unit 82. The service providing unit 82 includes a CPU (not shown) that executes predetermined processing according to a program, and a memory (not shown) for storing the program.

The service providing unit 82 provides services to the information terminal 10 requesting use of a service of the service providing server 8. Operations thereof are as follows. Upon receiving a service use request from the information terminal 10, the service providing unit 82 acquires a terminal identifier from the request, and makes an inquiry to the judgment server 9 as to whether a service may be provided to a user owning the terminal. When there is a response to the effect that service use is granted from the judgment server 9, a service is provided to the information terminal 10. When there is a response to the effect that service use is denied, a service is not provided to the information terminal 10. In the present embodiment, user names are to be used as terminal identifiers.

A description will now be given on the judgment server 9.

FIG. 35 is a block diagram showing a configuration example of a service judgment unit. As shown in FIG. 35, the judgment server 9 includes: a communication unit 91 that communicates with an external device via the network 50; and a service judgment unit 92. The service judgment unit 92 includes a CPU (not shown) that executes predetermined processing according to a program, and a memory (not shown) for storing the program.

The service judgment unit 92 judges whether a service may be provided to a user based on user information received from the service providing unit 82. Operations thereof are as follows. Upon receiving a presence input request to the information terminal 10 from the information terminal 1, the service judgment unit 92 acquires a user name of the information terminal 10 from the information, and stores the fact that a presence input request has been made to the user in a storage unit (not shown) inside the service judgment unit 92. Subsequently, upon receiving a service use availability confirmation from the service providing unit 82, the service judgment unit 92 acquires the user name of the confirmation source and references the storage unit to verify whether a presence input request has been made to the user. If an input request had been made to the user, a response of service use granted is issued, whereas if an input request had not been made, a response of service use denied is issued. When it is verified that the user that is the input request destination has inputted a presence, the record of the user in the storage unit is erased.

Instead of providing the judgment server 9 including the service judgment unit 92 independently on the network, the service judgment unit 92 may be provided inside the service providing server 8 or inside the presence server 2. In addition, the apparatus provided with the service judgment unit 92 need not be a server.

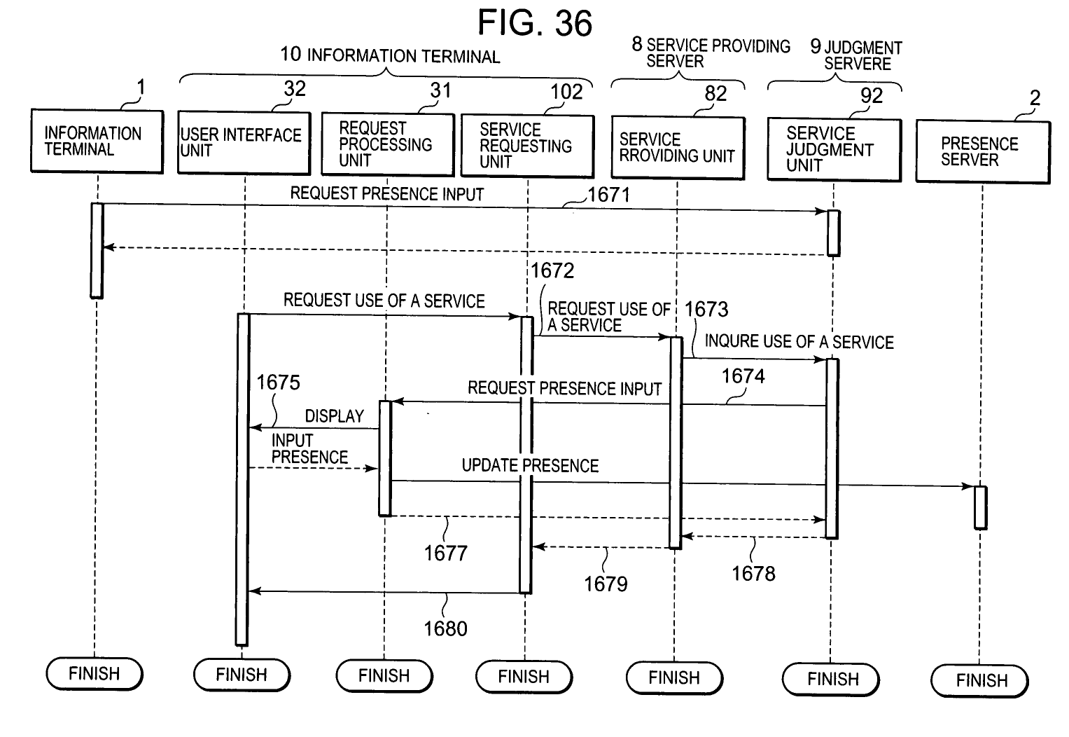

Next, an operation procedure of the information processing system according to the present embodiment will be described. FIG. 36 is a flowchart showing an operation procedure of the information processing system according to the present embodiment.

When the user A operates the information terminal 1 to request a presence input by the user B to the service judgment unit 92 (step 1671), the service judgment unit 92 saves the user name of the user B as information on a user who has been requested presence input in a storage unit (not shown) inside the service judgment unit 92.

When the user B operates the user interface unit 32 of the information terminal 10 to request use of a service for having an image in an electronic file displayed on the projector 85 to the service providing server 8 (step 1672), the service providing unit 82 of the service providing server 8 acquires a user name (user B) of the information terminal 10 and makes an inquiry to the service judgment unit 92 as to whether the user B may use the projector 85 (step 1673). If the user name of the user B is stored in the storage unit of the service judgment unit 92, the service judgment unit 92 requests presence input to the request processing unit 31 of the information terminal 10 (step 1674).

Upon receiving a presence input request from the service judgment unit 92, the request processing unit 31 of the information terminal 10 causes the presence input screen to be displayed on the display unit 16 (step 1675). As the user B operates the user interface unit 32 of the information terminal 10 to input a presence, the request processing unit 31 sends presence update information to the presence server 2 (step 1676). Furthermore, the request processing unit 31 notifies that a presence has been inputted to the service judgment unit 92 (step 1677).

Upon receiving a notification that a presence has been inputted from the information terminal 10, the service judgment unit 92 erases information on the user name of the user B from the storage unit inside the service judgment unit 92. Subsequently, as the service judgment unit 92 notifies permission of the user of the projector by the information terminal 10 to the service providing unit 82 (step 1678), the service providing unit 82 forwards the notification to the service requesting unit 102 of the information terminal 10 (step 1679). In addition, the service providing unit 82 causes image information in the electronic file received from the information terminal 10 to be displayed on the projector 85. The service requesting unit 102 of the information terminal 10 causes a message to the effect that service provision has been commenced to be displayed by the display unit (step 1680).

While a case has been described in which the user B is able to use a service, the following operations may be performed in a case where use of a service is denied. In step 1674, while the service judgment unit 92 requests presence input to the request processing unit 31, as a judgment result, the service judgment unit 92 may issue a response of “service use denied” to the service providing unit 82. In this case, the service providing unit 82 may issue a response of “service user denied” to the service requesting unit 102, whereby the service requesting unit 102 requests presence input to the request processing unit 31.

With the present embodiment, since the use of a service is granted by inputting a presence, the user himself/herself is apt to input a presence, and presence information can be acquired which is more accurate than setting a presence registered in advance to the presence server.

In addition, by requesting presence input to a user who has received a presence input request when the user attempts to use a service, the effort of repeatedly updating a presence that does not require updating at every attempt to use a service can be eliminated.

### Twelfth Embodiment

The present embodiment is arranged so that a side having requested presence input is able to cancel the request.

Configurations of the information processing system according to the present embodiment will be described below with reference to FIGS. 2 and 3. Hereinafter, configurations that differ from those of the first embodiment will be described in detail, and descriptions on configurations similar to those of the first embodiment will be omitted.

By having the request processing unit 31 shown in FIG. 3 receive a presence input request signal, after causing a presence input screen to be displayed on the display unit 16 and upon receiving a request cancellation signal for cancelling a presence input request, the presence input screen is erased by the display unit 16.

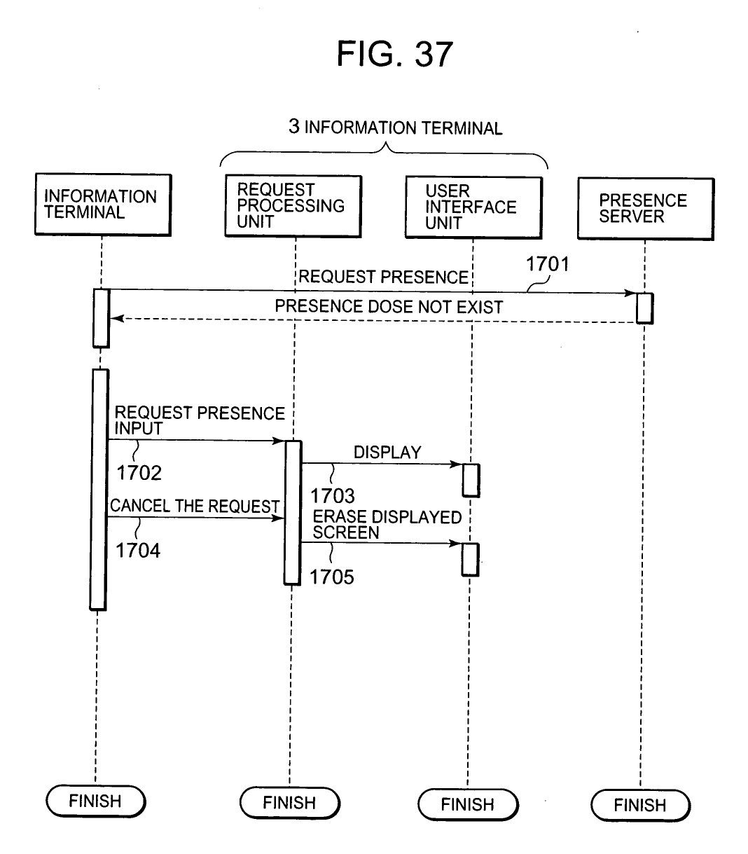

Next, an operation procedure of the information processing system according to the present embodiment will be described. FIG. 37 is a flowchart showing an operation procedure of the information processing system according to the present embodiment. Hereinafter, operations performed in addition to those of the first embodiment will be described in detail, and descriptions on portions similar to those of the first embodiment will be omitted.

In a similar manner as in the first embodiment, it is assumed that the user A had attempted to obtain the presence of the user B from the presence server 2 by operating the information terminal 1 but the presence of the user B was not registered in the presence server 2 (step 1701). As the user A operates the information terminal 1 to input a request for presence input to the user B, the information terminal 1 transmits a presence input request signal to the information terminal 3 via the network 50 (step 1702).

Upon receiving the presence input request signal from the information terminal 1, the request processing unit 31 of the information terminal 3 reads out the presence input screen and display period information and causes the presence input screen to be displayed on the display unit 16 (step 1703). Subsequently, as the user A determines that a presence of the user B is not required and operates the information terminal 1 to input an instruction for cancelling the presence input request, the information terminal 1 transmits a request cancellation signal to the information terminal 3 (step 1704).

Upon receiving the request cancellation signal from the information terminal 1, the request processing unit 31 of the information terminal 3 causes the display unit 16 to erase the presence input screen (step 1705).

In the present embodiment, when a side requesting a presence makes a presence input request but presence input becomes unnecessary before the other party inputs a presence, by having the side requesting a presence cancel the presence input request, an input screen displayed at the request destination is erased and a request destination user is no longer required to input a presence or to erase the input screen. Consequently, unnecessary operations on the side that had been requested presence input can be reduced.

While a description has been given using a case where the present embodiment is applied to the first embodiment, the present embodiment may instead be applied to each of the second to ninth embodiments. However, as described in the third embodiment, in the case where a user operates an information terminal to call an information terminal of another user, it is assumed that a request cancellation signal shall be transmitted from the information terminal of the user to the information terminal of the other party by breaking the connection.

### Thirteenth Example

While the twelfth embodiment has been arranged so that an information terminal of a user on the side being requested to input a presence erases a presence input screen upon receiving an instruction for cancelling the request, the present embodiment is arranged to that the presence input screen remains displayed. The present embodiment is a case where the twelfth embodiment is applied to the first embodiment, and configurations and operations which differ from the twelfth embodiment will be described in detail with reference to FIGS. 2 and 3.

In the present embodiment, even if a request cancellation signal described in the twelfth embodiment is received, the request processing unit 31 causes the presence input screen to be displayed on the display unit 16 until either a presence is inputted or an instruction for erasing the presence input screen is issued via the operating unit 17.

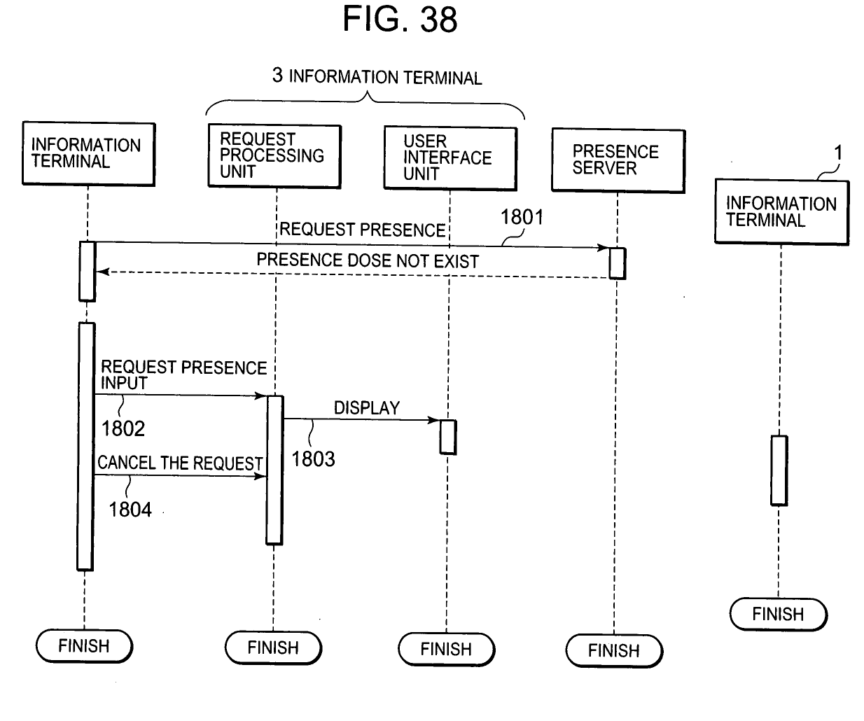

Next, an operation procedure of the information processing system according to the present embodiment will be described. FIG. 38 is a flowchart showing an operation procedure of the information processing system according to the present embodiment. Hereinafter, operations that differ from those of the first embodiment will be described in detail, and descriptions on portions similar to those of the first embodiment will be omitted.

In a similar manner as in the first embodiment, it is assumed that the user A had attempted to obtain the presence of the user B from the presence server 2 by operating the information terminal 1 but the presence of the user B was not registered in the presence server 2 (step 1801). As the user A operates the information terminal 1 to input a request for presence input to the user B, the information terminal 1 transmits a presence input request signal to the information terminal 3 via the network 50 (step 1802).

Upon receiving the presence input request signal from the information terminal 1, the request processing unit 31 of the information terminal 3 reads out the presence input screen and display period information and causes the presence input screen to be displayed on the display unit 16 (step 1803). Subsequently, as the user A determines that a presence of the user B is not required and operates the information terminal 1 to input an instruction for cancelling the presence input request, the information terminal 1 transmits a request cancellation signal to the information terminal 3 (step 1804).

Even when receiving a request cancellation signal from the information terminal 1, the request processing unit 31 of the information terminal 3 causes the presence input screen to be displayed on the display unit 16 until either a presence is inputted or an instruction for erasing the presence input screen is issued via the operating unit 17.

In the present embodiment, since the input screen displayed at the request destination remains as-is even when the presence requesting-side cancels the presence input request, the request destination user is more likely to input a presence.

While differences from the twelfth embodiment have been described for the present embodiment, contents of the present embodiment may be combined with applications of the twelfth embodiment to each of the first to ninth embodiments. However, as described in the third embodiment, in the case where a user operates an information terminal to call an information terminal of another user, it is assumed that a request cancellation signal will be transmitted from the information terminal of the user to the information terminal of the other party by breaking the connection.

The present invention can be applied to information processing systems for managing states of respective users via information terminals such as a mobile telephone, a PC, a PDA and a car navigation system.

1. An information terminal connected via a network to a server for disclosing a presence that is a present state of each user or each object, the information terminal comprising:
a display unit for displaying a presence input screen that is a screen for inputting the presence;
a storage unit storing a terminal identifier that differs from one user terminal to another and information on the presence input screen; and
a control unit that causes the presence input screen to be displayed on the display unit upon receiving a presence input request signal that is a signal for requesting input of the presence from another information terminal via the network, and when the presence is inputted via an operating unit, transmits the terminal identifier together with the presence to the server.

2. The information terminal according to claim 1, wherein
the storage unit stores one or more candidates with respect to the presence, and
the control unit causes the one or more candidates to be displayed by the display unit on the presence input screen upon receiving the presence input request signal.

3. The information terminal according to claim 1, wherein the control unit acknowledges a call signal received when there is an incoming call as the presence input request signal.

4. The information terminal according to claim 1, wherein the control unit transmits information on the presence to an information terminal at the transmission source of the presence input request signal.

5. The information terminal according to claim 3, wherein
the storage unit stores answering machine/forwarding setting information that is information regarding a setting of an answering machine or call forwarding, and
the control unit transmits the answering machine/forwarding setting information to a telephone server via the network when receiving the presence input request signal.

6. The information terminal according to claim 1, wherein
the storage unit stores information on a presence on non-input that is a presence set when the presence is not inputted and on a display period during which the presence input screen is displayed, and
the control unit receives the presence input request signal, causes the presence input screen to be displayed only during the display period, and if there is no input during the display period, transmits the presence on non-input to the server.

7. The information terminal according to claim 6, wherein the control unit causes the display unit to continue displaying the presence input screen if no presence is inputted during the display period.

8. The information terminal according to claim 1, wherein the control unit causes to erase the presence input screen when no presence is inputted during a display period that is a period in which the presence input screen is displayed.

9. The information terminal according to claim 6, wherein the control unit limits use of the terminal by controlling the display unit if no presence is inputted during the display period.

10. The information terminal according to claim 1, wherein the control unit causes the display unit to erase the presence input screen upon receiving a request cancellation signal for cancelling a request from a transmission source of the presence input request signal.

11. The information terminal according to claim 1, wherein the control unit causes the display unit to continue displaying the presence input screen even when receiving a request cancellation signal for cancelling a request from the transmission source of the presence input request signal.

12. The information terminal according to claim 1, wherein
the storage unit stores information on one or more candidates to become forwarding destinations of the presence input request signal, and
upon receiving the presence input request signal, the control unit causes the display unit to display information on the one or more candidates, and when a forwarding destination is selected from the one or more candidates, forwards the presence input request signal to one or more selected candidates.

13. The information terminal according to claim I, wherein
the storage unit stores information on one or more candidates to become forwarding destinations of the presence input request signal and on forwarding conditions, and
upon receiving the presence input request signal, the control unit selects a candidate satisfying the forwarding conditions from the one or more candidates, and forwards the presence input request signal to one or more selected candidates.

14. An information terminal connected via a network to a server for disclosing a presence that is a present state of each user, the information terminal comprising:
a storage unit storing information on one or more candidates to become a forwarding destination of a presence input request signal that is a signal requesting input of the presence to the server in regards to another information terminal when transmitting the presence input request signal to the other information terminal, and
a control unit that causes the display unit to display information on the one or more candidates when an instruction for requesting input of a presence to the other information terminal is inputted, and when a forwarding destination is selected from the one or more candidates, forwards the presence input request signal to one or more selected candidates.

15. An information terminal connected via a network to a server for disclosing a presence that is a present state of each user or each object, the information terminal comprising:
a storage unit storing information on one or more candidates to become a forwarding destination of a presence input request signal that is a signal requesting input of the presence to the server in regards to another information terminal when transmitting the presence input request signal to the other information terminal and on forwarding conditions; and
a control unit that selects a candidate satisfying the forwarding conditions from the one or more candidates when an instruction for requesting input of a presence to the other information terminal is inputted, and forwards the presence input request signal to one or more selected candidates.

16. A server apparatus connected via a network to a plurality of information terminals and to a service providing server that provides services, the server apparatus comprising:
a service judgment unit that judges whether a service is to be provided to a request destination information terminal that is an information terminal to which input of a presence is requested based on whether input of a presence has been requested to the request destination information terminal from another information terminal.

17. A server apparatus connected via a network to a plurality of information terminals, the server apparatus comprising:
a service judgment unit that judges whether a service is to be provided to a request destination information terminal that is an information terminal to which input of a presence is requested based on whether input of a presence has been requested to the request destination information terminal from another information terminal; and
a service providing unit that provides the service to the request destination information terminal when the service judgment unit judges that the service can be provided.

18. A server apparatus connected via a network to a plurality of information terminals and to a service providing server that provides services, the server apparatus comprising:
a presence management unit that stores a presence that is a present state of each user or each object and which discloses a presence in response to a request; and
a service judgment unit that judges whether a service is to be provided to one or more information terminals among the plurality of information terminals based on whether the one or more information terminals have been requested input of a presence from another information terminal.

19. A server apparatus connected via a network to a plurality of information terminals, the server apparatus comprising:
a storage unit storing information on one or more candidates to become a forwarding destination of a presence input request signal which is a signal requesting a presence that is a present state of a user with respect to a request destination information terminal that is an information terminal requested to input a presence and on forwarding conditions; and
a control unit that selects a candidate satisfying the forwarding conditions from the one or more candidates upon receiving the presence input request signal from another information terminal to the request destination information terminal, and forwards the presence input request signal to one or more selected candidates.

20. A server apparatus connected via a network to a plurality of information terminals and to a telephone server, the server apparatus comprising:
a storage unit storing answering machine/forwarding setting information that is information on a setting of an answering machine or call forwarding with respect to a request destination information terminal that is an information terminal requested to input a presence; and
a control unit that transmits the answering machine/forwarding setting information with respect to the request destination information terminal to the telephone server upon receiving information on a presence that is a present state of a user transmitted from the request destination information terminal to an information terminal to become a request source of the presence.

21. An information processing method performed by an information terminal connected via a network to a server for disclosing a presence that is a present state of each user or each object, wherein the information processing method:
stores a terminal identifier that differs from one user terminal to another and information on a presence input screen;
causes the presence input screen to be displayed on a display unit upon receiving a presence input request signal that is a signal for requesting input of the presence from another information terminal via the network; and
transmits the terminal identifier together with the presence to the server when the presence is inputted via an operating unit.

22. The information processing method according to claim 21, wherein the information processing method:
stores one or more candidates with respect to the presence; and
causes the display unit to display the one or more candidates on the presence input screen upon receiving the presence input request signal.

23. The information terminal according to claim 7, wherein the control unit limits use of the terminal by controlling the display unit if no presence is inputted during the display period.

24. The information terminal according to claim 8, wherein the control unit limits use of the terminal by controlling the display unit if no presence is inputted during the display period.
